(19) United States
(12) Patent Application Publication
(10) Pub. No.: US 2006/0205887 A1
(43) Pub. Date: Sep. 14, 2006

(54) Polymer and curable compositions improved in storage stability

(76) Inventors: Yoshiki Nakagawa, Osaka (JP); Nobuhiro Hasegawa, Osaka (JP); Yasuo Shimizu, Hyogo (JP); Jiro Okai, Osaka (JP); Nao Fujita, Osaka (JP); Hitoshi Tamai, Hyogo (JP); Ayako Yano, Hyogo (JP)

Correspondence Address: BRINKS HOFER GILSON & LIONE, P.O. BOX 10395, CHICAGO, IL, 60610, US

(21) Appl. No.: 10/541,996

(22) PCT Filed: Jan. 19, 2004
(86) PCT No.: PCT/JP04/00356

§ 371 Date: Apr. 10, 2006

(30) Foreign Application Priority Data
Jan. 22, 2003 (JP) 2003-013077
Jan. 22, 2003 (JP) 2003-01376

(51) Int. Cl. C08F 20/10

(52) U.S. Cl. 525/330.3

(57) ABSTRACT

A composition comprising a vinyl polymer having a crosslinkable silyl group may suffer from a delay in curing after the storage. The present invention relates to the following items. A curable composition comprising, as an essential component, (I) a vinyl polymer, which has at least one crosslinkable silyl group at the terminus and also has a monomer containing a methyl ester group as a constituent unit. A sealant, a liquid gasket, and an adhesive, wherein the above curable composition is used. A polymer has at least one crosslinkable functional group at the terminus and also has a vinyl polymer as a main chain thereof, wherein 2% to 80% by weight of monomers based on the total monomers constituting the main chain is methyl acrylate. A curable composition with improved storage stability, which comprises the following two components as essential components: (a) a vinyl polymer having at least one crosslinkable silyl group; and (b) a compound having a methyl ester group other than the compound (a).

### TECHNICAL FIELD

The present invention relates to a curable composition, which can be applied, for example, to a sealant, a gasket, or an adhesive, and a polymer having a crosslinkable functional group.

In addition, the present invention also relates to: a curable composition containing a vinyl polymer as an essential component, which has a crosslinkable silyl group at the terminus and has a specific monomer as a constituent unit; use of this polymer; a polymer containing a crosslinkable functional group at the terminus and having a specific monomer at a specific amount; and a curable composition, containing, as essential components, compound, which contains a vinyl polymer having a crosslinkable silyl group at the terminus and a compound which contains a methyl ester group.

### BACKGROUND ART

As curable compositions having a functional group at the terminus, moisture curing liquid polymers having a crosslinkable silyl group at the terminus thereof, the main chain of which is polysiloxane, polyoxypropylene, or polyisobutylene, have already been known. However, these curable compositions have problems to be improved. A polysiloxane composition is excellent in terms of weather resistance, heat resistance, cold resistance, flexibility, or the like, but is problematic in terms of staining properties caused by bleeding of low molecular weight components and coating properties. A polyoxypropylene composition is excellent in terms of flexibility, coating properties, and contamination resistance, but it is insufficient in terms of weather resistance in some cases. A polyisobutylene composition is good in terms of weather resistance and moisture permeation resistance. However, since it has a relatively high viscosity, it may be difficult to handle it in some cases. In addition, such a polyisobutylene composition requires some devices for processing into one component.

Polymers having an alkenyl group at the terminus are also used as curable compositions. It has been known that a cured product having excellent heat resistance, durability, and deep-curing properties can be obtained using a compound having a hydrosilyl group as a curing agent. As a main chain skeleton of such a polymer having an alkenyl group at the terminus, various skeletons have been known. Examples of such a skeleton may include: polyether polymers such as polyethylene oxide, polypropylene oxide, or polytetramethylene oxide; hydrocarbon polymers such as polybutadiene, polyisoprene, polychloroprene, poyisobutylene, or their hydrogenated products; polyester polymers such as polyethylene terephthalate, polybutylene terephthalate, or polycaprolactone; and silicon polymers such as polydimethylsiloxane.

Curable compositions using these polymers even have problems to be improved. For example, polyether cured products may be insufficient in terms of heat resistance or weather resistance, depending on purposes. Due to internal double bonds remaining in the main chain, hydrocarbon cured products such as polybutadiene or polyisoprene may be somewhat insufficient in terms of heat resistance or weather resistance, depending on purposes. Polyisobutylene cured products having no internal double bonds are excellent in terms of weather resistance, but these products have relatively high viscosity and thus it may be difficult to handle them in some cases. Polyester cured products may also be insufficient in terms of weather resistance, depending on purposes. Silicon cured products are superior in terms of weather resistance, heat resistance, cold resistance, and workability. However, these products are still problematic in terms of coating properties and staining properties.

Conventionally, acrylic rubber polymers, into which an active chlorine group or an epoxy group had been introduced, have been used for acrylic rubber compositions, which are used for molding, and thus, molded products having good heat resistance and oil resistance have been obtained. In order to respond to the need for achieving further improved heat resistance, a technique of introducing a vinyl group-containing organic silicon group has been proposed (refer to Japanese Patent Laid-Open No. 61-127711 and Japanese Patent Publication No. 2-1859). However, since a silicon group is not introduced into the terminus by such a technique, the obtained cured product is insufficient in terms of physical properties of rubber, such as elongation.

In order to solve such a problem, a (meth)acrylic polymer having a functional group at the terminus has been developed. In particular, a polymer synthesized using living radical polymerization is able to arbitrarily control molecular weight or molecular weight distribution. It also makes possible quantitative introduction of a functional group into the terminus. Consequently, this polymer can be used for a curable composition that is excellent in terms of weather resistance, heat resistance, oil resistance, or the like, having good mechanical properties.

The polymers described in Patent Document 1 are several examples of a vinyl polymer having a crosslinkable silyl group at the terminus. However, these publications do not refer to the curable composition of the present invention, which comprises a vinyl polymer having a crosslinkable silyl group at the terminus and having, as an essential component, a monomer having a methyl ester group. In addition, the publications do not describe possible solutions to improve delay in curing after the storage.

The polymers described in Patent Publication 2 are several examples of a (meth)acrylic polymer using methyl acrylate or methyl methacrylate as a monomer and having a functional group at the terminus. However, in these examples, the terminus is limited to a hydroxyl group, or the amount of methyl acrylate or methyl methacrylate used is not a suitable amount, which is described in the present invention.

Patent Document 3 describes an example of the invention relating to a technique of suppressing delay in curing of a curable composition comprising a polymer having a hydrolyzable silyl group-terminated functional group, which is similar to the present invention. However, the main chain of a polymer is polyether in this patent, and thus, constituent elements are completely different between the two inventions.

Moreover, Patent Document 4 describes several examples of a curable composition having, as an essential component, a vinyl polymer having a crosslinkable silyl group at the terminus. However, these publications do not refer to the use of a compound having a methyl ester group as an essential constituent unit, which is described in the present invention. Furthermore, the publications do not describe possible solutions to improve delay in curing after the storage.

[Patent Document 1]

Japanese Patent Laid-Open Nos. 11-201107, 11-80571, 11-116763, 2000-38404, 2000-44626, 2000-72815, and 2000-72816

[Patent Document 2]

Japanese Patent Laid-Open Nos. 9-272714 (pp. 16 to 21), 9-272715 (pp. 9 to 10), 11-80250 (pp. 16 to 20), 11-5815 (pp. 18 to 19), 11-80570 (pp. 13 to 17), and 11-116617 (pp. 16 to 29)

[Patent Document 3]

Japanese Patent Laid-Open No. 5-339490

[Patent Document 4]

Japanese Patent Laid-Open Nos. 9-272714, 9-272715, 11-043512, 11-80249, 11-80250, 11-5815, 11-80571, 11-100433, 11-116763, 11-130931, 11-116617, 2000-44626, 2000-128924, 2000-191728, 12-86998, 12-86999, 12-143853, 12-191912, 2000-186126, 2000-119527, 2000-154205, 2000-129199, 2000-178456, 2001-11319, 2001-271055, 2001-329065, 2001-303023, 2001-329025, and 2001-279108

A condensation curable composition having a crosslinkable silyl group is often problematic in that a curing rate is decreased due to degradation during the storage, so that the application thereof becomes difficult (that is, a problem regarding delay in curing). In particular, in the case of having a (meth)acrylic polymer as a component, such a problem tends to appear significantly. In addition, as described above, a vinyl polymer having a crosslinkable functional group at the terminus provides a curable composition having good mechanical properties, but a polymer capable of providing a cured product with higher strength or elongation is still required.

It is an object of the present invention to provide a curable composition having a crosslinkable silyl group at the terminus, regarding which the curing properties after the storage and/or the mechanical properties of a cured product obtained after curing are improved.

It is another object of the present invention to provide a polymer having a crosslinkable functional group at the terminus, which is able to provide a curable composition, regarding which the curing properties after the storage and/or the mechanical properties of a cured product obtained after curing are improved.

### DISCLOSURE OF THE INVENTION

As a result of intensive studies, the present inventors have found that the aforementioned objects can be achieved using a polymer having a methyl ester group, thereby completed the following invention.

The first aspect of the present invention relates to a curable composition comprising, as an essential component, (I) a vinyl polymer, which has at least one crosslinkable silyl group at the terminus and a monomer containing a methyl ester group as an essential constituent unit, the crosslinkable silyl group represented by general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

In the first aspect of the present invention, the vinyl polymer (I) is preferably a (meth)acrylic polymer. The term “(meth)acrylic polymer” is used to mean a polymer, 30% or more by weight of the constituent unit of which is a (meth)acrylic monomer. The monomer containing a methyl ester group which constitutes the vinyl polymer (I) is preferably methyl acrylate or methyl methacrylate, and more preferably methyl acrylate.

The vinyl polymer (I) is preferably in a liquid state at 23° C.

The vinyl polymer (I) is preferably synthesized by living radical polymerization, and more preferably synthesized by atom transfer radical polymerization.

The ratio of weight average molecular weight to number average molecular weight of vinyl polymer (I) is preferably less than 1.8. In this case, the ratio is determined by gel permeation chromatography.

The curable composition in the first aspect of the present invention is preferably a one-component curable composition.

The curable composition in the first aspect of the present invention preferably comprises a condensation curing catalyst (II). In addition, the condensation curing catalyst is preferably a tin curing catalyst.

The curable composition in the first aspect of the present invention preferably comprises an amine compound (III). In addition, an amino group contained in the amine compound is preferably a primary amine. Moreover, the amine compound is preferably a silane coupling agent.

In a preferred embodiment, the curable composition in the first aspect of the present invention comprises a polyether polymer having at least one crosslinkable silyl group represented by the general formula (1).

The second aspect of the present invention relates to a sealant, a liquid gasket, and an adhesive, wherein the curable composition in the first aspect of the present invention is used.

The third aspect of the present invention relates to a polymer, which has at least one crosslinkable functional group at the terminus and also has a vinyl polymer as a main chain thereof, wherein 2% to 80% by weight of monomers based on the total monomers constituting the main chain is methyl acrylate. Preferably, 5% to 50% by weight of monomers based on the total monomers constituting the main chain is methyl acrylate. More preferably, 5% to 20% by weight of monomers based on the total monomers constituting the main chain is methyl acrylate.

In another embodiment, the third aspect of the present invention relates to a polymer, which has at least one crosslinkable functional group at the terminus and also has a vinyl polymer as a main chain thereof, wherein 2% to 50% by weight of monomers based on the total monomers constituting the main chain is methyl methacrylate. Preferably, 2% to 20% by weight of monomers based on the total monomers constituting the main chain is methyl methacrylate.

The vinyl polymer as a main chain of the aforementioned polymer is preferably a (meth)acrylic polymer. The term “(meth)acrylic polymer” is used to mean a polymer, 30% or more by weight of the constituent unit of which is a (meth)acrylic monomer.

In the third aspect of the present invention, the main chain of the aforementioned polymer is preferably synthesized by living radical polymerization, and more preferably synthesized by atom transfer radical polymerization.

In the third aspect of the present invention, the crosslinkable functional group of the aforementioned polymer is preferably a crosslinkable silyl group represented by the general formula (1), an alkenyl group, a (meth)acryloyl group, or a hydroxyl group.

The fourth aspect of the present invention relates to a curable composition comprising the polymer according to the third aspect of the present invention as an essential component.

The fifth aspect of the present invention relates to a curable composition with improved storage stability, which comprises the following two components as essential components:

a vinyl polymer (I) having at least one crosslinkable silyl group represented by the above general formula (1); and

a compound (II) having a methyl ester group other than the compound (I).

In the fifth aspect of the present invention, the vinyl polymer (I) is preferably a (meth)acrylic polymer, and more preferably an acrylic ester polymer. The term “(meth)acrylic polymer” is used to mean a polymer, 30% or more by weight of the constituent unit of which is a (meth)acrylic monomer. Moreover, the crosslinkable silyl group represented by the general formula (1) is preferably located at the terminus of the vinyl polymer.

The vinyl polymer (I) is preferably in a liquid state at 23° C.

The vinyl polymer (I) is preferably synthesized by living radical polymerization, and more preferably synthesized by atom transfer radical polymerization.

The ratio of weight average molecular weight to number average molecular weight of vinyl polymer (I) is preferably less than 1.8. In this case, the ratio is determined by gel permeation chromatography.

The curable composition of the present invention is preferably a one-component curable composition.

In the fifth aspect of the present invention, the carbon atom at the α-position of the methyl ester group contained in the compound (II) having a methyl group other than the compound (I) is preferably primary or secondary. In addition, the compound (II) having a methyl ester group other than the compound (I) is preferably a dimethyl ester of dicarboxylic acid.

In the fifth aspect of the present invention, the compound (II) having a methyl ester group other than the compound (I) is preferably selected from the following group: dimethyl malonate, dimethyl succinate, dimethyl glutarate, dimethyl adipate, dimethyl sebacate, methyl acetate, methyl propionate, methyl butyrate, methyl valerate, methyl caprylate, methyl caprate, methyl laurate, methyl myristate, methyl palmitate, methyl stearate, methyl oleate, methyl ricinoleate, and coconut fatty acid methyl ester.

In the fifth aspect of the present invention, the compound (II) having a methyl ester group other than the compound (I) is preferably a polymer containing a monomer having a methyl ester group as a constituent unit.

In the fifth aspect of the present invention, the monomer having a methyl ester group is preferably methyl acrylate.

In the fifth aspect of the present invention, the compound having a methyl ester group is a copolymer containing a monomer having a methyl ester group as a constituent, and it is preferable that among ester groups contained in monomers other than the monomer having a methyl ester group, those having an alkoxy group that is primary and contains 5 or more carbon atoms make up 80% or less at a molar ratio with respect to the methyl ester groups.

In the fifth aspect of the present invention, the compound having a methyl ester group is a copolymer containing a monomer having a methyl ester group as a constituent, and it is preferable that among ester groups contained in monomers other than the monomer having a methyl ester group, those having an alkoxy group that is primary and contains 2 to 4 carbon atoms make up 400% or less at a molar ratio with respect to the methyl ester groups.

The curable composition in the fifth aspect of the present invention preferably comprises a condensation curing catalyst (III) as an essential component. In addition, the condensation curing catalyst is preferably a tin curing catalyst.

The curable composition in the fifth aspect of the present invention preferably comprises an amine compound (IV). In addition, an amino group contained in the amine compound is preferably a primary amine. Moreover, the amine compound is preferably a silane coupling agent.

In a preferred embodiment, the curable composition in the fifth aspect of the present invention comprises a polyether polymer having at least one crosslinkable silyl group represented by the general formula (1).

The sixth aspect of the present invention relates to a sealant, a liquid gasket, and an adhesive, wherein the curable composition in the fifth aspect of the present invention is used.

The seventh aspect of the present invention relates to a curable composition comprising, as an essential component, (I) a vinyl polymer having at least one crosslinkable silyl group represented by the above described general formula (1), wherein the a vinyl polymer comprises a compound having a methyl ester group.

### BEST MODE FOR CARRYING OUT THE INVENTION

<<First Invention>>

The first aspect of the present invention relates to a curable composition comprising, as an essential component, a vinyl polymer (I), which has at least one crosslinkable silyl group at the terminus and a monomer containing a methyl ester group as an essential constituent unit, the crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.
<Component (I)>
Crosslinkable Silyl Group Represented by General Formula (1)

Examples of a hydrolyzable group may include commonly used groups such as a hydrogen atom, alkoxy group, acyloxy group, ketoximate group, amino group, amide group, aminooxy group, mercapto group, or alkenyloxy group. Of these, an alkoxy group, an amide group, and aminooxy group are preferable. In terms of mild hydrolysis properties and handlability, an alkoxy group is particularly preferable.

1 to 3 hydrolyzable groups or hydroxyl groups are able to bind to a single silicon atom. The total of a and all of b, a+mb, is preferably between 1 and 5. When two or more hydrolyzable groups or hydroxyl groups bind into a crosslinkable silyl group, such groups may be either identical to or different from one another. The number of silicon atoms forming a crosslinkable silyl group is at least one. In the case of silicon atoms bound via a siloxane bond or the like, the number is preferably 20 or less. In particular, a crosslinkable silyl group represented by the following general formula (2):
—Si(R³)₃₋ₐ(Y)ₐ (2)
wherein R³, Y, and a have the same meanings as described above, is preferable because it is easily obtained.
Number of Crosslinkable Functional Groups

The number of crosslinkable functional groups in a vinyl polymer is not particularly limited. In order to obtain a cured product having high crosslinking properties, the mean number of such crosslinkable functional groups is 1 or more, preferably 1.2 or more, and more preferably 1.5 or more, per molecule of the vinyl polymer.

Position of Crosslinkable Functional Groups

When a molded product formed by curing the curable composition of the present invention is particularly required to have the properties of rubber, at least one crosslinkable silyl group is preferably located at the terminus of a molecular chain because it involves a large molecular weight between the crosslinking points, which significantly affects rubber elasticity. More preferably, all crosslinkable functional groups are located at the terminus of a molecular chain.

Monomer Containing a Methyl Ester Group

A monomer containing a methyl ester group is not particularly limited. Examples of such monomers may include methyl acrylate, methyl methacrylate, dimethyl maleate, and methyl ester-substituted styrene. In terms of easy polymerization and a high effect of suppressing delay in curing, methyl acrylate and methyl methacrylate are preferable, and methyl acrylate is particularly preferable.

The ratio of such a monomer having a methyl ester group to other monomers is not limited. In order to improve the storage stability of the curable composition of the present invention, it is preferable that many monomers having a methyl ester group be polymerized. In general, a polymer comprising monomers having a methyl ester group has a higher glass transition temperature than a polymer comprising monomers having other ester groups containing many carbon atoms. Thus, when a liquid resin is produced from such a polymer comprising monomers having a methyl ester group, the viscosity thereof may become high, or low-temperature properties may be deteriorated in some cases. It is therefore preferable that a right balance be maintained depending on properties of interest. Such a balance will be described later in the section regarding the third aspect of the present invention.

Vinyl Monomer Constituting Vinyl Polymer

In terms of the physical properties of a product to be obtained or the like, a vinyl monomer constituting the main chain of a vinyl polymer preferably comprises, as main components, alkyl (meth)acrylate and/or alkoxyalkyl (meth)acrylate.

Examples of alkyl (meth)acrylate may include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, and stearyl (meth)acrylate. Of these, methyl acrylate, ethyl acrylate, butyl acrylate, isobutyl acrylate, and 2-ethylhexyl acrylate are preferable. Ethyl acrylate and butyl acrylate are particularly preferable.

Examples of alkoxyalkyl (meth)acrylate may include 2-methoxyethyl (meth)acrylate, 2-ethoxyethyl (meth)acrylate, and 3-methoxybutyl (meth)acrylate. Of these, 2-methoxyethyl acrylate and 2-ethoxyethyl (meth)acrylate are particularly preferable.

In order to control physical properties, in addition to alkyl (meth)acrylate and alkoxyalkyl (meth)acrylate, the following vinyl monomers may also be copolymerized. Examples of a vinyl monomer capable of being copolymerized may include: (meth)acrylic monomers such as (meth)acrylic acid, phenyl (meth)acrylate, toluyl (meth)acrylate, benzyl (meth)acrylate, 2-hydroxyethyl (meth)acrylate, 2-hydroxypropyl (meth)acrylate, glycidyl (meth)acrylate, 2-aminoethyl (meth)acrylate, γ-(methacryloyloxypropyl)trimethoxysilane, an ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, or 2-perfluorohexadecylethyl (meth)acrylate; styrene monomers such as styrene, vinyltoluene, α-methylstyrene, chlorstyrene, or styrene sulfonate and a salt thereof; fluorine-containing vinyl monomers such as perfluoroethylene, perfluoropropylene, or vinylidene fluoride; silicon-containing vinyl monomers such as vinyltrimethoxysilane or vinyltriethoxysilane; maleic anhydride, maleic acid, and a monoalkyl ester and a dialkyl ester of maleic acid; fumaric acid, and a monoalkyl ester and a dialkyl ester of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide, or cyclohexylmaleimide; nitrile-containing vinyl monomers such as acrylonitrile or methacrylonitrile; amide group-containing vinyl monomers such as acrylamide or methacrylamide; vinyl esters such as vinyl acetate, vinyl propionate, vinyl pivalate, vinyl benzoate, or vinyl cinnamate; alkenes such as ethylene or propylene; conjugated dienes such as butadiene or isoprene; and vinyl chloride, vinylidene chloride, allyl chloride, and allyl alcohol.

Properties such as oil resistance, heat resistance, or cold resistance can be controlled by changing the composition ratio of alkyl (meth)acrylate and/or alkoxyalkyl (meth)acrylate, which are the main constituent units of a vinyl polymer.

For example, in order to obtain a cured product having a well balance of rubber elasticity, oil resistance, heat resistance, cold resistance, surface tackiness, and surface staining properties, a vinyl polymer preferably comprises alkyl acrylate at a weight ratio between 60% and 80% based on the total weight of vinyl monomers constituting the vinyl polymer and alkoxyalkyl acrylate at a weight ratio between 20% and 40% based on the total weight of vinyl monomers constituting the vinyl polymer. In this case, a vinyl polymer, which comprises ethyl acrylate at a weight ratio between 30% and 50% based on the total weight of vinyl monomers, butyl acrylate at a weight ratio between 20% and 40% based on the total weight of vinyl monomers, and 2-methoxyethyl acrylate at a weight ratio between 20% and 40% based on the total weight of vinyl monomers, is well balanced. A vinyl polymer, which comprises ethyl acrylate at a weight ratio between 50% and 80%, butyl acrylate at a weight ratio between 0% and 20%, and 2-methoxyethyl acrylate at a weight ratio between 20% and 40%, is more excellent in terms of oil resistance. In addition, a vinyl polymer, which comprises ethyl acrylate at a weight ratio between 0% and 30%, butyl acrylate at a weight ratio between 40% and 80%, and 2-methoxyethyl acrylate at a weight ratio between 20% and 40%, is more excellent in terms of cold resistance.

When oil resistance and cold resistance are particularly emphasized, a vinyl polymer preferably comprises alkyl acrylate at a weight ratio between 20% and 60% based on the total weight of vinyl monomers constituting the vinyl polymer, and alkoxyalkyl acrylate at a weight ratio between 40% and 80% based on the total weight of vinyl monomers constituting the vinyl polymer. In this case, when a vinyl polymer comprises ethyl acrylate and butyl acrylate whose total weight is at a weight ratio between 20% and 60% based on the total vinyl monomers constituting the vinyl polymer, and 2-methoxyethyl acrylate at a weight ratio between 40% and 80% based on the total vinyl monomers constituting the vinyl polymer, it is more excellent in terms of oil resistance and cold resistance. Thus, such a vinyl polymer is more preferable. When a vinyl polymer comprises ethyl acrylate at a weight ratio between 10% and 30% based on the total weight of vinyl monomers constituting the vinyl polymer, butyl acrylate at a weight ratio between 10% and 30% based on the total weight of vinyl monomers constituting the vinyl polymer, and 2-methoxyethyl acrylate at a weight ratio between 40% and 80% based on the total weight of vinyl monomers constituting the vinyl polymer, it is excellent in terms of oil resistance and cold resistance. When a vinyl polymer comprises ethyl acrylate at a weight ratio between 0% and 10% based on the total weight of vinyl monomers constituting the vinyl polymer, butyl acrylate at a weight ratio between 30% and 60% based on the total weight of vinyl monomers constituting the vinyl polymer, and 2-methoxyethyl acrylate at a weight ratio between 40% and 80% based on the total weight of vinyl monomers constituting the vinyl polymer, it is particularly excellent in terms of cold resistance. When a vinyl polymer comprises ethyl acrylate at a weight ratio between 30% and 60% based on the total weight of vinyl monomers constituting the vinyl polymer, butyl acrylate at a weight ratio between 0% and 10% based on the total weight of vinyl monomers constituting the vinyl polymer, and 2-methoxyethyl acrylate at a weight ratio between 40% and 80% based on the total weight of vinyl monomers constituting the vinyl polymer, it is excellent in terms of oil resistance and cold resistance.

When oil resistance and heat resistance are particularly emphasized, a vinyl polymer preferably comprises alkyl acrylate at a weight ratio between 80% and 100% based on the total weight of vinyl monomers constituting the vinyl polymer, and alkoxyalkyl acrylate at a weight ratio between 0% and 20% based on the total weight of vinyl monomers constituting the vinyl polymer. In this case, when a vinyl polymer comprises ethyl acrylate at a weight ratio between 40% and 60% based on the total weight of vinyl monomers constituting the vinyl polymer, butyl acrylate at a weight ratio between 40% and 60% based on the total weight of vinyl monomers constituting the vinyl polymer, and 2-methoxyethyl acrylate at a weight ratio between 1% and 20% based on the total vinyl monomers constituting the vinyl polymer, it is excellent in terms of rubber elasticity, as well as oil resistance and heat resistance. When a vinyl polymer comprises ethyl acrylate at a weight ratio between 60% and 100% based on the total weight of vinyl monomers constituting the vinyl polymer, butyl acrylate at a weight ratio between 0% and 40% based on the total weight of vinyl monomers constituting the vinyl polymer, and 2-methoxyethyl acrylate at a weight ratio between 0% and 20% based on the total weight of vinyl monomers constituting the vinyl polymer, it is excellent in terms of oil resistance, heat resistance, surface tackiness, and surface staining properties. When a vinyl polymer comprises ethyl acrylate at a weight ratio between 0% and 40% based on the total weight of vinyl monomers constituting the vinyl polymer, butyl acrylate at a weight ratio between 60% and 100% based on the total weight of vinyl monomers constituting the vinyl polymer, and 2-methoxyethyl acrylate at a weight ratio between 0% and 20% based on the total weight of vinyl monomers constituting the vinyl polymer, it is excellent in terms of oil resistance, heat resistance, and rubber elasticity.

Molecular Weight and Molecular Weight Distribution of Vinyl Polymer

The molecular weight distribution of the aforementioned vinyl polymer, that is, the ratio of weight average molecular weight to number average molecular weight of vinyl polymer (I) is not particularly limited. In this case, the ratio is determined by gel permeation chromatography.

It is generally less than 1.8, preferably 1.7 or less, more preferably 1.6 or less, further more preferably 1.5 or less, particularly preferably 1.4 or less, and most preferably 1.3 or less. In the GPC measurement in the present invention, chloroform is generally used as a mobile phase, and the measurement is conducted with a polystyrene gel column. The number average molecular weight or the like can be calculated relative to polystyrene.

The number average molecular weight of the aforementioned vinyl polymer is not particularly limited. It is preferably within a range between 500 and 1,000,000, and more preferably between 1,000 and 100,000.

Method for Polymerizing Vinyl Polymer

A method for polymerizing a vinyl polymer is not limited in the present invention. Control radical polymerization is preferable, living radical polymerization is more preferable, and atom transfer radical polymerization is particularly preferable. These polymerization methods will be described below.

(Control Radical Polymerization)

Radical polymerization method can be classified into two types: “general radical polymerization method,” which simply copolymerizes a monomer having a specific functional group and a vinyl monomer using an azo compound or peroxide as a polymerization initiator; and “control radical polymerization method,” which enables introduction of a specific functional group into a specific site such as a terminus.

Such a “general radical polymerization method” is a simple method. However, monomers having a specific functional group are introduced into a polymer only at a certain probability, in this method. Thus, this method is problematic in that when a polymer containing large quantities of a functional group is intended to be obtained, it is required to use such monomers at a considerably large amount. In contrast, when such monomers are used at a small amount, the ratio of polymers, into which such a specific functional group has not been introduced, increases. In addition, since this is free radical polymerization, it is also problematic in that only polymers having a wide molecular weight distribution and a high viscosity can be obtained.

The “control radical polymerization method” is further classified into the “chain transfer agent method,” in which polymerization is carried out using a chain transfer agent having a specific functional group, so as to obtain a vinyl polymer having a functional group at the terminus, and the “living radical polymerization method,” in which polymers having almost the desired molecular weight can be obtained, while a polymerization growth terminus does not cause a termination reaction or the like.

The “chain transfer agent method” enables the obtainment of polymers with high functionality. This method requires a considerably large amount of chain transfer agent having a specific functional group with respect to an initiator. Thus, this method is problematic in terms of economic aspect including treatment. In addition, as with the aforementioned “general radical polymerization method,” since this is free radical polymerization, it is also problematic in that only polymers having a wide molecular weight distribution and a high viscosity can be obtained.

A radical polymerization process is difficult to control on account of the high polymerization, and termination reaction due to coupling of radicals easily occurs. Unlike these polymerization processes, by the living radical polymerization, a polymer with a narrow molecular weight distribution (Mw/Mn of about 1.1 to 1.5) can be obtained because termination reaction little occurs, and the molecular weight can be freely controlled by controlling the charge ratio of the monomer to the initiator.

Accordingly, the “living radical polymerization method” enables the obtainment of polymers with a narrow molecular weight distribution and a low viscosity. In addition, since monomers having a specific functional group can be introduced into almost any given sites of such polymers by this method, the “living radical polymerization method” is preferable as a method for producing the above described vinyl polymer having a specific functional group.

In the narrow sense, the term “living polymerization” means polymerization in which termini constantly maintain activity and a molecular chain grows. However, in general, the term “living polymerization” also include pseudo-living polymerization in which a molecular chain grows although inactivated termini and activated termini are present in an equilibrium state. The definition in the present invention is also the latter one.

In recent years, the “living radical polymerization method” has actively been studied by various study groups. Examples of such studies may include: the use of a cobalt-porphyrin complex, described in Journal of American Chemical Society (J. Am. Chem. Soc.), 1994, vol. 116, p. 7943; the use of a radical scavenger such as a nitroxide compound, described in Macromolecules, 1994, vol. 27, p. 7228; and “atom transfer radical polymerization” (ATRP) using an organic halide as an initiator and a transition metal complex as a catalyst.

Among such “living radical polymerization methods,” the “atom transfer radical polymerization method,” which polymerizes a vinyl monomer using an organic halide or halogenated sulfonyl compound as an initiator and a transition metal complex as a catalyst, does not only have the characteristics of the aforementioned “living radical polymerization method”, but this method also involves halogens or the like that are relatively advantageous for a functional group-conversion reaction at the terminus and has a high degree of flexibility in designing such an initiator and a catalyst. Accordingly, the atom transfer radical polymerization method is more preferable as a method for producing a vinyl polymer having a specific functional group. This atom transfer radical polymerization method is described, for example, in Matyjaszewski et al., Journal of American Chemical Society (J. Am. Chem. Soc.), 1995, vol. 117, p. 5614; Macromolecules, 1995, vol. 28, p. 7901; Science, 1996, vol. 272, p. 866; WO96/30421; WO97/18247; WO98/01480; WO98/40415; Sawamoto et al., Macromolecules, 1995, vol. 28, p. 1721; Japanese Patent Laid-Open No. 9-208616; and Japanese patent Laid-Open No. 8-41117.

In the present invention, it is not particularly limited, which of these living radical polymerization methods is applied. However, the atom transfer radical polymerization method is preferable.

Living radical polymerization will be described in detail below. However, before the description of the living radical polymerization, a control radical polymerization usable for the production of a vinyl polymer that will be described later, that is, a polymerization using a chain transfer agent, will be described. A radical polymerization using a chain transfer agent (telomer) is not particularly limited. In order to obtain a vinyl polymer having a terminal structure that is suitable for the present invention, there are the following two types of methods:

That is, a method for obtaining a polymer having halogen at the terminus using halogenated hydrocarbon as a chain transfer agent, described in Japanese Patent Laid-Open No. 4-132706; and methods for obtaining a polymer having a hydroxyl group at the terminus using hydroxyl group-containing mercaptan or hydroxyl group-containing polysulfide as a chain transfer agent, described in Japanese Patent Laid-Open No. 61-271306, Japanese Patent No. 2594402, and Japanese Patent Laid-Open No. 54-47782.

Living radical polymerization will be described below.

First, a method using a radical scavenger such as a nitroxide compound will be described. In this polymerization, a generally stable nitroxy free radical (═N—O.) is used as a radical capping agent. Such compounds used as free radicals are not limited. Preferred examples may include nitroxy free radicals from cyclic hydroxylamine, such as 2,2,6,6-substituted-1-piperidinyloxy radical or 2,2,5,5-substituted-1-pyrrolidinyloxy radical. An alkyl group containing 4 or less carbon atoms, such as a methyl group or ethyl group, is suitable as a substituent. Specific examples of a nitroxy free radical compound, but are not limited to, may include 2,2,6,6-tetramethyl-1-piperidinyloxy radical (TEMPO), 2,2,6,6-tetraethyl-1-piperidinyloxy radical, 2,2,6,6-tetramethyl-4-oxo-1-piperidinyloxy radical, 2,2,5,5-tetramethyl-1-pyrrolidinyloxy radical, 1,1,3,3-tetramethyl-2-isoindolinyloxy radical, and N,N-di-t-butylamineoxy radical. A stable free radical such as a galvinoxyl free radical may also be used instead of nitroxy free radical.

The aforementioned radical capping agent is used in combination with a radical generator. It is considered that a reaction product obtained by the reaction between such a radical capping agent and a radical generator acts as a polymerization initiator, and that the polymerization of addition polymer monomers thereby progresses. The ratio of the two agents combined is not particularly limited. It is appropriate that 0.1 to 10 moles of the radical initiator be used with respect to 1 mole of the radical capping agent.

Various compounds can be used as radical generators. Peroxide capable of generating radicals under polymerization temperature conditions is preferable. Such peroxide is not limited. Examples of such peroxide may include: diacyl peroxides such as benzoyl peroxide or lauroyl peroxide; dialkyl peroxides such as dicumyl peroxide or di-t-butyl peroxide; peroxy carbonates such as diisopropylperoxy dicarbonate or bis(4-t-butylcyclohexyl)peroxy dicarbonate; and alkyl peresters such as t-butylperoxy octoate or t-butylperoxy benzoate. Of these, benzoyl peroxide is particularly preferable. In addition, radical generators including a radical-generating azo compound such an azobisisobutylonitrile may also be used instead of peroxide.

As described in Macromolecules, 1995, 28, 2993, an alkoxyamine compound shown in the following figure may be used as an initiator, instead of the combined use of a radical capping agent and a radical generator.

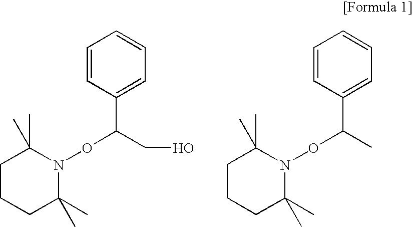

When an alkoxyamine compound is used as an initiator, if the compound having a functional group such as a hydroxyl group shown in the above figure is used, a polymer having a functional group at the terminus can be obtained. If this technique is applied to the method of the present invention, a polymer having a functional group at the terminus is obtained.

Monomers, solvents, and polymerization conditions such as a polymerization temperature, which are used in the polymerization using a radical scavenger such as the aforementioned nitroxide compound, are not limited. The same conditions as used in the atom transfer radical polymerization that will be described next, can be applied.

Next, the “atom transfer radical polymerization” that is preferable for the present invention will be described below.

The atom transfer radical polymerization of the present invention includes what is called reverse atom transfer radical polymerization. Reverse atom transfer radical polymerization is a method of allowing a general radical initiator such as peroxide to act on Cu(II′) in a high oxidization state when a general atom transfer radical polymerization catalyst generates radicals, for example, when Cu(I) is used as a catalyst, so as to obtain an equilibrium state that is equivalent to that in the atom transfer radical polymerization (refer to Macromolecules, 1999, 32, 2872).

In the atom transfer radical polymerization, an organic halide, and particularly, an organic halide having a highly reactive carbon-halogen bond (for example, a carbonyl compound having halogen at the α-position, or a compound having halogen at benzyl position), or a halogenated sulfonyl compound, is used as an initiator.

Specific examples of such an initiator may include:
C₆H₅—CH₂X,
C₆H₅—C(H)(X)CH₃,
C₆H₅—C(X)(CH₃)₂
wherein, in the above chemical formulae, C₆H₅ represents a phenyl group; and X represents chlorine, bromine, or iodine,
R¹¹—C(H)(X)—CO₂R¹²,
R¹¹—C(CH₃)(X)—CO₂R¹²,
R¹¹—C(H)(X)—C(O)R¹², or
R¹¹—C(CH₃)(X)—C(O)R¹²,
wherein, in the above formulae, each of R¹¹ and R¹² represents a hydrogen atom, an alkyl group containing 1 to 20 carbon atoms, an aryl group, or aralkyl group; and X represents chlorine, bromine, or iodine, and
R¹¹—C₆H₄—SO₂X
wherein, in the above formula, R¹¹ represents a hydrogen atom, an alkyl group containing 1 to 20 carbon atoms, an aryl group, or an aralkyl group; and X represents chlorine, bromine, or iodine.

As an initiator for the atom transfer radical polymerization, organic halides or halogenated sulfonyl compounds that have a functional group other than the functional group used for initiation of the polymerization may also be used. In such a case, a vinyl polymer, which has a functional group at one main chain terminus and the growth terminal structure of the atom transfer radical polymerization at the other main chain terminus, is produced. Examples of such a functional group may include an alkenyl group, a crosslinkable silyl group, a hydroxyl group, an epoxy group, an amino group, and an amide group.

An organic halide having an alkenyl group is not limited. An organic halide having the structure shown in general formula (3) indicated below is an example.
R¹⁴R¹⁵C(X)—R¹⁶—R¹⁷—C(R¹³)═CH₂ (3)
wherein R¹³ represents hydrogen or a methyl group; each of R¹⁴ and R¹⁵ represents hydrogen, a monovalent alkyl group containing 1 to 20 carbon atoms, an aryl group, an aralkyl group, or a ligated body formed by ligating to each other at the other terminus; R¹⁶ represents —C(O)O— (ester group), —C(O)— (keto group), or an o-, m- or p-phenylene group; R¹⁷ represents a direct bond or a divalent organic group containing 1 to 20 carbon atoms that may contain at least one ether bond; and X represents chlorine, bromine, or iodine.

Specific examples of substituents R¹⁴ and R¹⁵ may include hydrogen, a methyl group, an ethyl group, an n-propyl group, an isopropyl group, a butyl group, a pentyl group, and a hexyl group. R¹⁴ and R¹⁵ may be ligated to each other at the other terminus, so as to form a cyclic skeleton.

Specific examples of an organic halide having an alkenyl group shown in the general formula (3) may include:

XCH₂C(O)O(CH₂)ₙCH═CH₂, H₃CC(H)(X)C(O)O(CH₂)ₙCH═CH₂, (H₃C)₂C(X)C(O)O(CH₂)ₙCH═CH₂, and CH₃CH₂C(H)(X)C(O)O(CH₂)ₙCH═CH₂, 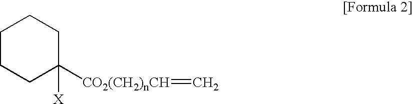
wherein, X represents chlorine, bromine, or iodine; and n represents an integer between 0 and 20,

XCH₂C(O)O(CH₂)ₙO(CH₂)ₘCH═CH₂, H₃CC(H)(X)C(O)O(CH₂)ₙO(CH₂)ₘCH═CH₂, (H₃C)₂C(X)C(O)O(CH₂)ₙO(CH₂)ₘCH═CH₂, and CH₃CH₂C(H)(X)C(O)O(CH₂)ₙO(CH₂)ₘCH═CH₂, 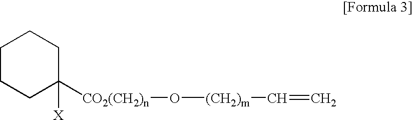
wherein X represents chlorine, bromine, or iodine; n represents an integer between 1 and 20; and m represents an integer between 0 and 20,

o,m,p-XCH₂—C₆H₄—(CH₂)ₙ—CH═CH₂, o,m,p-CH₃C(H)(X)—C₆H₄—(CH₂)ₙ—CH═CH₂, and o,m,p-CH₃CH₂C(H)(X)—C₆H₄—(CH₂)ₙ—CH═CH₂,

wherein X represents chlorine, bromine, or iodine; and n represents an integer between 0 and 20,

o,m,p-XCH₂—C₆H₄—(CH₂)ₙ—O—(CH₂)ₘ—CH═CH₂, o,m,p-CH₃C(H)(X)—C₆H₄—(CH₂)ₙ—O—(CH₂)ₘ—CH═CH₂, and o,m,p-CH₃CH₂C(H)(X)—C₆H₄—(CH₂)ₙ—O—(CH₂)ₘCH═CH₂,

wherein X represents chlorine, bromine, or iodine; n represents an integer between 1 and 20; and m represents an integer between 0 and 20,

o,m,p-XCH₂—C₆H₄—O—(CH₂)ₙ—CH═CH₂, o,m,p-CH₃C(H)(X)—C₆H₄—O—(CH₂)ₙ—CH═CH₂, and o,m,p-CH₃CH₂C(H)(X)—C₆H₄—O—(CH₂)ₙ—CH═CH₂,

wherein X represents chlorine, bromine, or iodine; and n represents an integer between 0 and 20,

o,m,p-XCH₂—C₆H₄—O—(CH₂)ₙ—O—(CH₂)ₘ—CH═CH₂, o,m,p-CH₃C(H)(X)—C₆H₄—O—(CH₂)ₙ—O—(CH₂)ₘ—CH═CH₂, and o,m,p-CH₃CH₂C(H)(X)—C₆H₄—O—(CH₂)ₙ—O—(CH₂)ₘ—CH═CH₂,

wherein X represents chlorine, bromine, or iodine; n represents an integer between 1 and 20; and m represents an integer between 0 and 20.

As an organic halide having an alkenyl group, a compound represented by the following general formula (4) can be used:
H₂C═C(R¹³)—R¹⁷—C(R¹⁴)(X)—R¹⁸—R¹⁵ (4)
wherein R¹³, R¹⁴, R¹⁵, R¹⁷, and X have the same meanings as described above; and R¹⁸ represents a direct bond, —C(O)O—(ester group), —C(O)— (keto group), or an o-, m- or p-phenylene group.

R¹⁷ represents a direct bond, or a divalent organic group containing 1 to 20 carbon atoms (which may contain at least one ether bond). When R¹⁷ represents a direct bond, a vinyl group binds to the carbon to which halogen binds, and it is a halogenated allyl compound. In this case, since a carbon-halogen bond is activated by a vinyl group adjacent thereto, a C(O)O group, a phenylene group, or the like is not necessarily required as R¹⁸, and it may also be a direct bond. When R¹⁷ is not a direct bond, a C(O)O group, a C(O) group, or a phenylene group is preferably used as R¹⁸ to activate a carbon-halogen bond.

Specific examples of a compound represented by the general formula (4) may include:

CH₂═CHCH₂X, CH₂═C(CH₃)CH₂X, CH₂═CHC(H)(X)CH₃, CH₂═C(CH₃)C(H)(X)CH₃, CH₂═CHC(X)(CH₃)₂, CH₂═CHC(H)(X)C₂H₅, CH₂═CHC(H)(X)CH(CH₃)₂, CH₂═CHC(H)(X)C₆H₅, CH₂═CHC(H)(X)CH₂C₆H₅, CH₂═CHCH₂C(H)(X)—CO₂R, CH₂═CH(CH₂)₂C(H)(X)—CO₂R, CH₂═CH(CH₂)₃C(H)(X)—CO₂R, CH₂═CH(CH₂)₈C(H)(X)—CO₂R, CH₂═CHCH₂C(H)(X)—C₆H₅, CH₂═CH(CH₂)₂C(H)(X)—C₆H₅, and CH₂═CH(CH₂)₃C(H)(X)—C₆H₅,

wherein X represents chlorine, bromine, or iodine; and R represents an alkyl group containing 1 to 20 carbon atoms, an aryl group, or an aralkyl group.

Specific examples of a halogenated sulfonyl compound having an alkenyl group may include o-, m-, p-CH₂═CH—(CH₂)ₙ—C₆H₄—SO₂X, and o-, m-, p-CH₂═CH—(CH₂)ₙ—O—C₆H₄—SO₂X,

wherein X represents chlorine, bromine, or iodine; and n represents an integer between 0 and 20.

The aforementioned organic halide having a crosslinkable silyl group is not particularly limited. For example, an organic halide having the structure shown in the following general formula (5) is used:
R¹⁴R¹⁵C(X)—R¹⁶—R¹⁷—C(H)(R¹³)CH₂—[Si(R¹⁹)_{2-b}(Y)_{b}O]ₘ—Si(R²⁰)₃₋ₐ(Y)ₐ (5)
wherein R¹³, R¹⁴, R¹⁵, R¹⁶, R¹⁷, and X have the same meanings as described above; each of R¹⁹ and R²⁰ represents an alkyl group containing 1 to 20 carbon atoms, an aryl group, or an aralkyl group, or a triorganosiloxy group represented by (R′)₃SiO—, wherein R′ represents a monovalent hydrocarbon group containing 1 to 20 carbon atoms, and three R′s may be identical to or different from one another, and when two or more R¹⁹s or R²⁰ s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

Specific examples of a compound represented by the general formula (5) may include:

XCH₂C(O)O(CH₂)ₙSi(OCH₃)₃, CH₃C(H) (X)C(O)O(CH₂)ₙSi(OCH₃)₃, (CH₃)₂C(X)C(O)O(CH₂)ₙSi(OCH₃)₃, XCH₂C(O)O(CH₂)ₙSi(CH₃)(OCH₃)₂, CH₃C(H)(X)C(O)O(CH₂)ₙSi(CH₃)(OCH₃)₂, and (CH₃)₂C(X)C(O)O(CH₂)Si(CH₃)(OCH₃)₂,

wherein X represents chlorine, bromine, or iodine; and n represents an integer between 0 and 20,

XCH₂C(O)O(CH₂)ₙO(CH₂)ₘSi(OCH₃)₃, H₃CC(H)(X)C(O)O(CH₂)ₙO(CH₂)ₘSi(OCH₃)₃, (H₃C)₂C(X)C(O)O(CH₂)ₙO(CH₂)ₘSi(OCH₃)₃, CH₃CH₂C(H)(X)C(O)O(CH₂)ₙO(CH₂)ₘSi(OCH₃)₃, XCH₂C(O)O(CH₂)O(CH₂)ₘSi (CH₃)(OCH₃)₂, H₃CC(H)(X)C(O)O(CH₂)ₙO(CH₂)ₘ—Si(CH₃)(OCH₃)₂, (H₃C)₂C(X)C(O)O(CH₂)ₙO(CH₂)ₘ—Si(CH₃)(OCH₃)₂ and CH₃CH₂C(H)(X)C(O)O(CH₂)ₙO(CH₂)ₘ—Si(CH₃)(OCH₃)₂,

wherein X represents chlorine, bromine, or iodine; n represents an integer between 1 and 20; and m represents an integer between 0 and 20,

o,m,p-XCH₂—C₆H₄—(CH₂)₂Si (OCH₃)₃, o,m,p-CH₃C(H)(X)—C₆H₄—(CH₂)₂Si(OCH₃)₃, o,m,p-CH₃CH₂C(H)(X)—C₆H₄—(CH₂)₂Si(OCH₃)₃, o,m,p-XCH₂—C₆H₄—(CH₂)₃Si(OCH₃)₃, o,m,p-CH₃C(H)(X)—C₆H₄—(CH₂)₃Si(OCH₃)₃, o,m,p-CH₃CH₂C(H)(X)—C₆H₄—(CH₂)₃Si(OCH₃)₃, o,m,p-XCH₂—C₆H₄—(CH₂)₂—O—(CH₂)₃Si(OCH₃)₃, o,m,p-CH₃C(H)(X)—C₆H₄—(CH₂)₂—O—(CH₂)₃Si(OCH₃)₃, o,m,p-CH₃CH₂C(H)(X)—C₆H₄—(CH₂)₂—O—(CH₂)₃Si(OCH₃)₃, o,m,p-XCH₂—C₆H₄—O—(CH₂)₃Si(OCH₃)₃, o,m,p-CH₃C(H)(X)—C₆H₄—O—(CH₂)₃Si(OCH₃)₃, o,m,p-CH₃CH₂C(H)(X)—C₆H₄—O—(CH₂)₃—Si(OCH₃)₃, o,m,p-XCH₂—C₆H₄—O—(CH₂)₂—O—(CH₂)₃—Si(OCH₃)₃, o,m,p-CH₃C(H)(X)—C₆H₄—O—(CH₂)₂—O—(CH₂)₃Si(OCH₃)₃, and o,m,p-CH₃CH₂C(H)(X)—C₆H₄—O—(CH₂)₂—O—(CH₂)₃Si(OCH₃)₃,

wherein X represents chlorine, bromine, or iodine.

An organic halide having the structure shown in the following general formula (6) is another example of the aforementioned organic halide having a crosslinkable silyl group.
(R²⁰)₃₋ₐ(Y)ₐSi—[OSi(R¹⁹)_{2-b}(Y)_{b}]ₘ—CH₂—C(H)(R¹³)—R¹⁷—C(R¹⁴)(X)—R¹⁸—R¹⁵ (6)
wherein R¹³, R¹⁴, R¹⁵, R¹⁷, R¹⁸, R¹⁹, R²⁰, a, b, m, X, and Y have the same meanings as described above.

Specific examples of such a compound may include:

(CH₃O)₃SiCH₂CH₂C(H)(X)C₆H₅, (CH₃O)₂(CH₃)SiCH₂CH₂C(H)(X)C₆H₅, (CH₃O)₃Si(CH₂)₂C(H)(X)—CO₂R, (CH₃O)₂(CH₃)Si(CH₂)₂C(H)(X)—CO₂R, (CH₃O)₃Si(CH₂)₃C(H)(X)—CO₂R, (CH₃O)₂(CH₃)Si(CH₂)₃C(H)(X)—CO₂R, (CH₃O)₃Si(CH₂)₄C(H)(X)—CO₂R, (CH₃O)₂(CH₃)Si(CH₂)₄C(H)(X)—CO₂R, (CH₃O)₃Si(CH₂)₉C(H)(X)—CO₂R, (CH₃O)₂(CH₃)Si(CH₂)₉C(H)(X)—CO₂R, (CH₃O)₃Si(CH₂)₃C(H)(X)—C₆H₅, (CH₃O)₂(CH₃)Si(CH₂)₃C(H)(X)—C₆H₅, (CH₃O)₃Si(CH₂)₄C(H)(X)—C₆H₅, and (CH₃O)₂(CH₃)Si(CH₂)₄C(H)(X)—C₆H₅,

wherein X represents chlorine, bromine, or iodine; and R represents an alkyl group containing 1 to 20 carbon atoms, an aryl group, or an aralkyl group.

The aforementioned organic halide or halogenated sulfonyl compound having a hydroxyl group is not particularly limited. For example, a compound represented by the following formula is used:
HO—(CH₂)ₙ—OC(O)C(H)(R)(X)
wherein X represents chlorine, bromine, or iodine; R represents an alkyl group containing 1 to 20 carbon atoms, an aryl group, or an aralkyl group; and n represents an integer between 1 and 20.

The aforementioned organic halide or halogenated sulfonyl compound having an amino group is not particularly limited. For example, a compound represented by the following formula is used:
H₂N—(CH₂)—OC(O)C(H)(R)(X)

wherein, X represents chlorine, bromine, or iodine; R represents a hydrogen atom, an alkyl group containing 1 to 20 carbon atoms, an aryl group, or an aralkyl group; and n represents an integer between 1 and 20.

The aforementioned organic halide or halogenated sulfonyl compound having an epoxy group is not particularly limited. For example, a compound represented by the following formula is used: 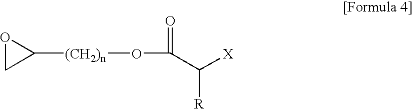
wherein X represents chlorine, bromine, or iodine; R represents a hydrogen atom, an alkyl group containing 1 to 20 carbon atoms, an aryl group, or an aralkyl group; and n represents an integer between 1 and 20.

In order to obtain a polymer having two or more terminal structures of the present invention in a single molecule, an organic halide or halogenated sulfonyl compound having two or more initiation points is preferably used as an initiator. Specific examples may include: 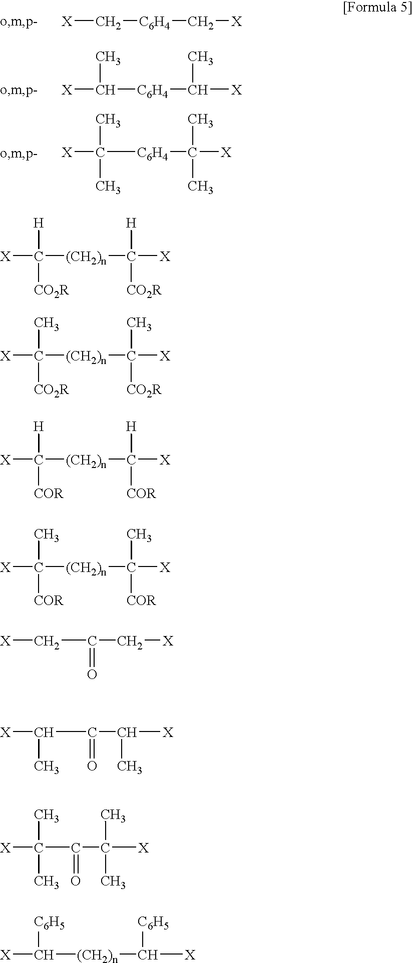
wherein X represents chlorine, bromine, or iodine; R represents a hydrogen atom, an alkyl group containing 1 to 20 carbon atoms, an aryl group, or an aralkyl group; and n represents an integer between 1 and 20, 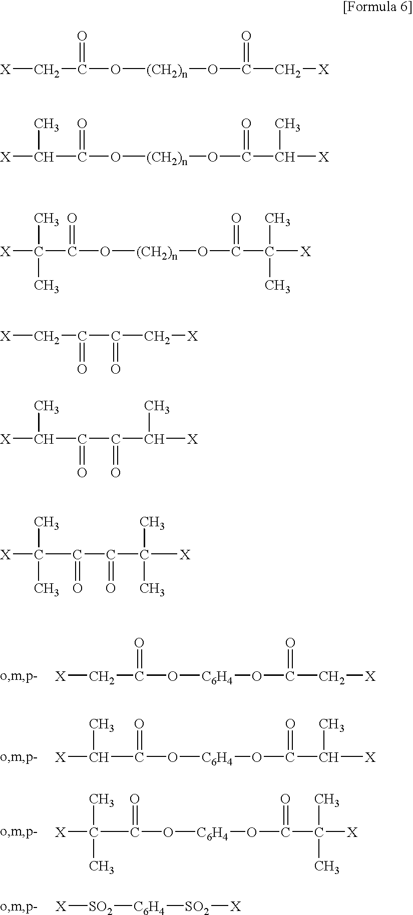
wherein X represents chlorine, bromine, or iodine; and n represents an integer between 1 and 20.

The type of a vinyl monomer used in this polymerization is not particularly limited, and all of the above described examples can preferably be used.

The type of a transition metal complex used as a polymerization catalyst is not particularly limited. Preferred examples of such a transition metal complex may include metal complexes that contain, as a central metal, the 7^{th} group, 8^{th} group, 9^{th} group, 10^{th} group, or 11^{th} group element of the periodic table. More preferred examples may include complexes of zero-valent copper, monovalent copper, divalent ruthenium, divalent iron, or divalent nickel. Of these, a copper complex is preferable. Specific examples of a monovalent copper compound may include cuprous chloride, cuprous bromide, cuprous iodide, cuprous cyanide, cuprous oxide, and cuprous perchlorate. When a copper compound is used, in order to enhance catalytic activity, ligands including 2,2′-bipyridyl or a derivative thereof, 1,10-phenanthroline or a derivative thereof, or polyamines such as tetramethylethylenediamine, pentamethyldiethylenetriamine, or hexamethyltris(2-aminoethyl)amine, are added. In addition, a tristriphenylphosphine complex of divalent ruthenium chloride (RuCl₂(PPh₃)₃) is also preferable as a catalyst. When a ruthenium compound is used as a catalyst, aluminum alkoxides are added as activators. Moreover, a bistriphenylphosphine complex of divalent iron (FeCl₂(PPh₃)₂), a bistriphenylphosphine complex of divalent nickel (NiCl₂(PPh₃)₂), and a bistributylphosphine complex of divalent nickel (NiBr₂(PBu₃)₂) are also preferable as catalysts.

Polymerization can be carried out in no solvents or in various types of solvents. Examples of the type of a solvent may include: hydrocarbon solvents such as benzene or toluene; ether solvents such as diethyl ether or tetrahydrofuran; halogenated hydrocarbon solvents such as methylene chloride or chloroform; ketone solvents such as acetone, methyl ethyl ketone, or methyl isobutyl ketone; alcohol solvents such as methanol, ethanol, propanol, isopropanol, n-butyl alcohol, or tert-butyl alcohol; nitrile solvents such as acetonitrile, propionitrile, or benzonitrile; ester solvents such as ethyl acetate or butyl acetate; and carbonate solvents such as ethylene carbonate or propylene carbonate. These solvents can be used singly or in combination with two or more types. Polymerization can be carried out within a temperature range between 0° C. and 200° C., and preferably between 50° C. and 150° C., but the temperature range is not limited thereto.

Method for Introducing Crosslinkable Silyl Group into Vinyl Polymer

Next, a method for introducing a crosslinkable silyl group into a vinyl polymer will be described, but the method is not limited to the following examples.

First, a method for introducing a crosslinkable silyl group, an alkenyl group, and a hydroxyl group into a vinyl polymer by conversion of a functional group at the terminus, will be described. Since such a functional group can act as precursors for one another, explanation begins with a crosslinkable silyl group.

Examples of a method for synthesizing a vinyl polymer having at least one crosslinkable silyl group may include: (A) a method of adding a hydrosilane compound having a crosslinkable silyl group to a vinyl polymer having at least one alkenyl group in the presence of a hydrosilylation catalyst; (B) a method of allowing a compound having, in a single molecule thereof, crosslinkable silyl groups and a group capable of reacting with a hydroxyl group, such as an isocyanate group, to react with a vinyl polymer having at least one hydroxyl group; (C) a method of allowing a compound having a polymerizable alkenyl group and a crosslinkable silyl group in a single molecule thereof, to react with a vinyl polymer when such a vinyl polymer is synthesized by radical polymerization; (D) a method of using a chain transfer agent having a crosslinkable silyl group when a vinyl polymer is synthesized by radical polymerization; and (E) a method of allowing a compound having a crosslinkable silyl group and stable carbanions in a single molecule thereof to react with a vinyl polymer having at least one highly reactive carbon-halogen bond.

The vinyl polymer having at least one alkenyl group used in the method (A) can be obtained by various methods. Examples of such synthesis methods will be given below, but methods are not limited to such examples.

(A-a) A method of allowing a compound used as a second monomer represented by the following general formula (7), which has a polymerizable alkenyl group and an alkenyl group with a low polymerization degree in a single molecule thereof, to react with a vinyl polymer, when the vinyl polymer is synthesized by radical polymerization:
H₂C═C(R²⁴)—R²⁵—R²⁶—C(R²⁷)═CH₂ (7)
wherein R²⁴ represents hydrogen or a methyl group; R²⁵ represents —C(O)O—, or an o-, m-, or p-phenylene group; R²⁶ represents a direct bond, or a divalent organic group containing 1 to 20 carbon atoms, which may contain at least one ether bond; and R²⁷ represents hydrogen, an alkyl group containing 1 to 20 carbon atoms, an aryl group containing 6 to 20 carbon atoms, or an aralkyl group containing 7 to 20 carbon atoms.

The timing of allowing a compound having a polymerizable alkenyl group and an alkenyl group with a low polymerization degree, in a single molecule thereof, to react with a vinyl polymer, is not limited. In particular, when living radical polymerization is carried out and high properties of rubber are anticipated, it is preferable that the above compound used as a second monomer be allowed to react with a vinyl polymer at the terminal stage of the polymerization reaction, or after completion of the reaction of certain monomers.

(A-b) A method of allowing a compound having at least two alkenyl groups with a low polymerization degree, such as 1,5-hexadiene, 1,7-octadiene, or 1,9-decadiene, to react with a vinyl polymer, at the terminal stage of the polymerization reaction, or after completion of the reaction of certain monomers, during the synthesis of the vinyl polymer by atom transfer radical polymerization.

(A-c) A method of allowing various types of organic metal compounds having an alkenyl group, including organic tins such as allyl tributyl tin or allyl trioctyl tin, to react with a vinyl polymer having at least one highly reactive carbon-halogen bond at the terminus produced by atom transfer radical polymerization, so as to substitute halogens.

(A-d) A method of allowing stabilized carbanions having an alkenyl group represented by the following general formula (8) to react with a vinyl polymer having at least one highly reactive carbon-halogen bond at the terminus produced by atom transfer radical polymerization, so as to substitute halogens:
M⁺C⁻(R²⁸)(R²⁹)—R³⁰—C(R²⁷)═CH₂ (8)
wherein R²⁷ has the same meaning as described above; both R²⁸ and R²⁹ represent an electron attracting group for stabilizing carbanion C⁻, or either one of R²⁸ and R²⁹ represents the above attracting group and the other represents hydrogen, an alkyl group containing 1 to 10 carbon atoms, or a phenyl group; R³⁰ represents a direct bond or a divalent organic group containing 1 to 10 carbon atoms, which may contain at least one ether bond; and M⁺ represents an alkali metal ion or a quarternary ammonium ion.

As the electron attracting group represented by R²⁸ and R²⁹, those having the structures, —CO₂R, —C(O)R, and —CN are particularly preferable.

(A-e) A method, which comprises: allowing a metal simplex such as zinc or an organic metal compound to act on a vinyl polymer having at least one highly reactive carbon-halogen bond at the terminus produced by atom transfer radical polymerization, so as to prepare enolate anions; and then allowing the obtained enolate anions to react with electrophilic compounds having an alkenyl group, such as an alkenyl group-containing compound having a leaving group such as halogen or an acetyl group, a carbonyl compound having an alkenyl group, an isocyanate compound having an alkenyl group, or an acid halide having an alkenyl group.

(A-f) A method of allowing oxyanions or carboxylate anions having an alkenyl group represented by the following general formula (9) or (10) to react with a vinyl polymer having at least one highly reactive carbon-halogen bond at the terminus produced by atom transfer radical polymerization, so as to substitute halogens:
H₂C═C(R²⁷)—R³¹—O⁻M⁺ (9)
wherein R²⁷ and M⁺ have the same meanings as described above; and R²¹ represents a divalent organic group containing 1 to 20 carbon atoms, which may contain at least one ether bond,
H₂C═C(R²⁷)—R³²—C(O)O⁻M⁺ (10)
wherein R²⁷ and M⁺ have the same meanings as described above; and R²² represents a direct bond, or a divalent organic group containing 1 to 20 carbon atoms, which may contain at least one ether bond.

Such a vinyl polymer having at least one alkenyl group can also be obtained from a vinyl polymer having at least one hydroxyl group. Methods mentioned below are applied, but examples are not limited to such methods. Examples of such a method may include:

(A-g) a method of allowing a base such as sodium methoxide to act on a hydroxyl group contained in a vinyl polymer having at least one hydroxyl group, and then allowing the resultant to react with an alkenyl group-containing halide such as allyl chloride;

(A-h) a method of allowing an alkenyl group-containing isocyanate compound such as allyl isocyanate to react with a hydroxyl group contained in a vinyl polymer having at least one hydroxyl group;

(A-i) a method of allowing an alkenyl group-containing halide such as (meth)acrylic chloride to react with a hydroxyl group contained in a vinyl polymer having at least one hydroxyl group in the presence of a base such as pyridine; and

(A-j) a method of allowing alkenyl group-containing carboxylic acid such as acrylic acid to react with a hydroxyl group contained in a vinyl polymer having at least one hydroxyl group in the presence of an acid catalyst.

Of the above described production methods, the method (A-b) is more preferable in terms of controllability.

By allowing a vinyl polymer having an alkenyl group produced by the above described methods to react with a hydrosilane compound having a crosslinkable silyl group, the alkenyl group can be converted into a crosslinkable silyl group. A hydrosilane compound having a crosslinkable silyl group is not particularly limited. The compound represented by the following general formula (11) is a representative example of such a hydrosilane compound having a crosslinkable silyl group.
H—[Si(R⁹)_{2-b}(Y)_{b}O]ₘSi(R¹⁰)₃₋ₐ(Y)ₐ (11)
wherein each of R⁹ and R¹⁰ represents an alkyl represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R⁹s or R¹⁰s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

Of these hydroxysilane compounds, a compound having crosslinkable groups represented by the following general formula (12) is particularly preferable because it is easily obtained:
H—Si(R¹⁰)₃₋ₐ(Y)ₐ (12)
wherein R¹⁰, Y, and a have the same meanings as described above.

When the aforementioned hydrosilane compound having a crosslinkable silyl group is added to an alkenyl group, a transition metal catalyst is generally used. Examples of a transition metal catalyst may include: a platinum simplex; a product formed by dispersing a platinum solid into a carrier such as alumina, silica, or carbon black; chloroplatinic acid; a complex of chloroplatinic acid with alcohol, aldehyde, ketone, or the like; a platinum-olefin complex; and a platinum (0)-divinyltetramethyldisiloxane complex. Examples of a catalyst other than a platinum compound may include RhCl(PPh₃)₃, RhCl₃, RuCl₃, IrCl₃, FeCl₃, AlCl₃, PdCl₂.H₂O, NiCl₂, and TiCl₄.

Examples of a method for producing a vinyl polymer having at least one hydroxyl group that is used in the methods (B) and (A-g) to (A-j), but are not limited to, will be given below.

(B-a) A method of allowing a compound used as a second monomer that has a polymerizable alkenyl group and a hydroxyl group in a single molecule thereof represented by the following general formula (13) to react with a vinyl polymer, when the vinyl polymer is synthesized by atom transfer radical polymerization:
H₂C═C(R²⁴)—R²⁵—R²⁶—OH (13)
wherein R²⁴, R²⁵, and R²⁶ have the same meanings as described above.

The timing of allowing a compound having a polymerizable alkenyl group and a hydroxyl group in a single molecule thereof to react with a vinyl polymer is not limited. In particular, when a molded product obtained is expected to have high properties of rubber, it is preferable that the above compound used as a second monomer be allowed to react with a vinyl polymer at the terminal stage of the polymerization reaction, or after completion of the reaction of certain monomers.

(B-b) A method of allowing alkenyl alcohol such as 10-undecenol, 5-hexenol, or allyl alcohol, to react with a vinyl polymer, at the terminal stage of the polymerization reaction, or after completion of the reaction of certain monomers, when the vinyl polymer is synthesized by atom transfer radical polymerization.

(B-g) A method of allowing stabilized carbanions having a hydroxyl group represented by the following general formula (14) to react with a vinyl polymer having at least one highly reactive carbon-halogen bond at the terminus produced by atom transfer radical polymerization, so as to substitute halogens:
M⁺C⁻(R²⁸)(R²⁹)—R³⁰—OH (14)
wherein R²⁸, R²⁹, and R³⁰ have the same meanings as described above.

As the electron attracting group represented by R²⁸ and R²⁹, those having the structures, —CO₂R, —C(O)R, and —CN, are particularly preferable.

(B-h) A method, which comprises: allowing a metal simplex such as zinc or an organic metal compound to act on a vinyl polymer having at least one highly reactive carbon-halogen bond at the terminus produced by atom transfer radical polymerization, so as to prepare enolate anions; and then allowing aldehydes or ketones to react with the enolate anions.

(B-i) A method of allowing oxyanions or carboxylate anions having a hydroxyl group represented by the following general formula (15) or (16) to react with a vinyl polymer having at least one highly reactive carbon-halogen bond at the terminus produced by atom transfer radical polymerization, so as to substitute halogens:
HO—R³¹—O⁻M⁺ (15)
wherein R³¹ and M⁺ have the same meanings as described above,
HO—R³²—C(O)O⁻M⁺ (16)
wherein R³² and M⁺ have the same meanings as described above.

(B-j) A method of allowing a compound used as a second monomer that has an alkenyl group with a low polymerization degree and a hydroxyl group in a single molecule thereof, to react with a vinyl polymer, at the terminal stage of the polymerization reaction, or after completion of the reaction of certain monomers, during the synthesis of the vinyl polymer by atom transfer radical polymerization.

Such a compound is not particularly limited. The compound represented by the following general formula (17) is an example of such a compound:
H₂C═C(R²⁴)—R³¹—OH (17)
wherein R²⁴ and R³¹ have the same meanings as described above.

The compound represented by the above general formula (18) is not particularly limited. Preferred examples may include alkenyl alcohols such as 10-undecenol, 5-hexenol, or allyl alcohol, because they are easily obtained.

Of the production methods (B-a), (B-b), (B-g) to (B-e), and (B-j), the method (B-b) is more preferable in terms of controllability.

Examples of a compound having, in a single molecule thereof, a crosslinkable silyl group and a group capable of reacting with a hydroxyl group, such as an isocyanate group, may include γ-isocyanatepropyltrimethoxysilane, γ-isocyanatepropylmethyldimethoxysilane, and γ-isocyanatepropyltriethoxysilane. Generally known catalysts that are used for urethanation reactions can be used herein, as necessary.

Examples of a compound having a polymerizable alkenyl group and a crosslinkable silyl group in a single molecule thereof that is used in the method (C) may include compounds represented by the following general formula (18), such as trimethoxysilylpropyl (meth)acrylate or methyldimethoxysilylpropyl (meth)acrylate:
H₂C═C(R²⁴)—R²⁵—R³³—[Si(R⁹)^{2-b}(Y)_{b}O]ₘ—Si(R¹⁰)₃₋ₐ(Y)ₐ (18)
wherein R⁹, R¹⁰, R²⁴, R²⁵, Y, a, b, and m have the same meanings as described above; and R³³ represents a direct bond, or a divalent organic group containing 1 to 20 carbon atoms, which may contain at least ether bond.

The timing of allowing a compound having a polymerizable alkenyl group and a crosslinkable silyl group in a single molecule thereof to react with a vinyl polymer is not limited. In particular, when living radical polymerization is carried out and high properties of rubber are anticipated, it is preferable that the above compound used as a second monomer be allowed to react with a vinyl polymer at the terminal stage of the polymerization reaction, or after completion of the reaction of certain monomers.

Examples of a chain transfer agent having a crosslinkable silyl group used in the chain transfer agent method (D) may include mercaptan having a crosslinkable silyl group and hydrosilane having a crosslinkable silyl group, which are described in Japanese Patent Publication Nos. 3-14068 and 4-55444.

The above-described vinyl polymer having at least one highly reactive carbon-halogen bond used in the method (E) is synthesized by the atom transfer radical polymerization method. The compound represented by the following general formula (19) is an example of a compound having a crosslinkable silyl group and stabilized carbanions in a single molecule thereof:
M⁺C⁻(R²⁸)(R²⁹)—R³⁴—C(H)(R³⁵)—CH₂—[Si(R⁹)_{2-b}(Y)_{b}O]ₘ—Si(R¹⁰)₃₋ₐ(Y)ₐ (19)
wherein R⁹, R¹⁰, R²⁸, R²⁹, Y, a, b, and m have the same meanings as described above; R³⁴ represents a direct bond, or a divalent organic group containing 1 to 10 carbon atoms, which may contain at least one ether bond; and R³⁵ represents hydrogen, an alkyl group containing 1 to 10 carbon atoms, an aryl group containing 6 to 10 carbon atoms, and an aralkyl group containing 7 to 10 carbon atoms.

As the electron attracting group represented by R²⁸ and R²⁹, those having the structures —CO₂R, —C(O)R, and —CN are particularly preferable.

<Curable Composition>

The present invention relates to a curable composition comprising the above described vinyl polymer having a crosslinkable silyl group.

Form of Curable Composition

The curable composition of the present invention may be prepared in the form of a one-component composition by previously mixing all components, hermetically conserving the obtained mixture, and curing it with moisture contained in the air after using it. Alternatively, components such as a curing catalyst, a filler, a plasticizer, and water have been mixed in advance, separately. Thereafter, the mixed material may be mixed with a polymer composition before use. Thus, the curable composition of the present invention may also be prepared in the form of a two-component composition.

Decrease in storage stability, which is the problem to be solved by the present invention, often occurs in the one-component composition wherein a catalyst or a silane coupling agent are mixed before storage. Thus, in order to sufficiently obtain the effects of the present invention, the one-component composition is preferable.

Mixed Material

For a curable composition comprising a polymer having a crosslinkable silyl group, a curing catalyst or a silane coupling agent is often mixed. Decrease in storage stability, which is the problem to be solved by the present invention, often occurs in a case where such a curing catalyst or silane coupling agent is mixed. Thus, in order to sufficiently obtain the effects of the present invention, a mixture containing these components is preferable. In addition, various types of additives may be added, depending on physical properties of interest.

(Component (II): Condensation Catalyst)

A polymer having a crosslinkable silyl group is crosslinked and cured by forming a siloxane bond in the presence or absence of various types of condensation catalysts that have previously been known. Various types of cured products ranging from a rubber product to a resin product can be produced, depending on the molecular weight of a polymer and a main chain skeleton thereof.

Examples of such a condensation catalyst may include: silanol condensation catalysts, which include tetravalent tin compounds such as dibutyltin dilaurate, dibutyltin diacetate, dibutyltin diethyl hexanoate, dibutyltin dioctate, dibutyltin dimethyl maleate, dibutyltin diethyl maleate, dibutyltin dibutyl maleate, dibutyltin diisooctyl maleate, dibutyltin ditridecyl maleate, dibutyltin dibenzyl maleate, dibutyltin maleate, dioctyltin diacetate, dioctyltin distearate, dioctyltin dilaurate, dioctyltin diethyl maleate, or dioctyltin diisooctyl maleate; divalent tin compounds such as tin octoate, tin naphthenate, or tin stearate; titanates such as tetrabutyl titanate or tetrapropyl titanate; organic aluminum compounds such as aluminum trisacetyl acetonate, aluminum trisethyl acetoacetate, or diisopropoxyaluminum ethyl acetoacetate; chelate compounds such as zirconium tetraacetyl acetonate or titanium tetraacetyl acetonate; zinc octoate; amine compounds such as butylamine, octylamine, laurylamine, dibutylamine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole, or 1,8-diazabicyclo(5,4,0)undecen-7 (DBU); salts with carboxylic acids of these amine compounds; reaction products and mixtures between laurylamines and tin octoates; low molecular weight polyamide resins obtained from excessive polyamines and polybasic acids; reaction products between excessive polyamines and epoxy compounds; silane coupling agents having an amino group, such as γ-aminopropyltrimethoxysilane or N-(β-aminoethyl)aminopropylmethyldimethoxysilane, and further, known silanol condensation catalysts including other acid catalysts and basic catalysts.

In the case of a one-component composition, tetravalent tin compounds are often used in terms of curing properties. Decrease in storage stability, which is a problem to be solved by the present invention, often occurs when such a tetravalent tin compound is mixed. Accordingly, in order to sufficiently obtain the effects of the present invention, such tetravalent tin compounds are preferably used.

These catalysts may be used singly or in combination with two or more types. Such a condensation catalyst is mixed at an amount preferably between approximately 0.1 and 20 parts, and more preferably between 1 and 10 parts, with respect to 100 parts (parts by weight; hereinafter the term “part” is defined in the same manner). If the amount of a silanol condensation catalyst mixed were below the above range, a curing speed would decrease, or a curing reaction would not sufficiently progress. In contrast, if the amount of a silanol condensation catalyst mixed exceeded the above range, local heating or bubbles would be generated during the curing reaction, and thereby a good curing product would be hardly obtained. In addition, a pot life would become too short, and thus it is not preferable in terms of workability. In order to control curing properties, tin curing catalysts are preferably used, although catalysts are not particularly limited thereto.

(Component (III): Amine Compound)

In order to maintain the adhesiveness of a curable composition or to improve catalytic activity, amine compounds are preferably added as component (III). As amine compounds, aminosilanes that will be described later in the “silane coupling agent” section are preferable, and aminosilanes having a primary amino group are particularly preferable. Decrease in storage stability, which is a problem to be solved by the present invention, often occurs when an amine compound is added, and particularly when a primary amine compound is added. Accordingly, in order to sufficiently obtain the effects of the present invention, a mixture to which these amine compounds are added is preferable.

(Silane Coupling Agent)

Silane coupling agents, or agents for imparting adhesiveness to compositions other than the silane coupling agents, can be added to the curable composition of the present invention. Specific examples of such a silane coupling agent may include: isocyanate group-containing silanes such as γ-isocyanatepropyltrimethoxysilane, γ-isocyanatepropyltriethoxysilane, γ-isocyanatepropylmethyldiethoxysilane, or γ-isocyanatepropylmethyldimethoxysilane; amino group-containing silanes such as γ-aminopropyltrimethoxysilane, γ-aminopropyltriethoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-ureidepropyltrimethoxysilane, N-phenyl-γ-aminopropyltrimethoxysilane, N-benzyl-γ-aminopropyltrimethoxysilane, or N-vinylbenzyl-γ-aminopropyltriethoxysilane; mercapto group-containing silanes such as γ-mercaptopropyltrimethoxysilane, γ-mercaptopropyltriethoxysilane, γ-mercaptopropylmethyldimethoxysilane, or γ-mercaptopropylmethyldiethoxysilane; epoxy group-containing silanes such as γ-glycidoxypropyltrimethoxysilane, γ-glycidoxypropyltriethoxysilane, γ-glycidoxypropylmethyldimethoxysilane, β-(3,4-epoxycyclohexyl)ethyltrimethoxysilane, or β-(3,4-epoxycyclohexyl)ethyltriethoxysilane; carboxysilanes such as β-carboxyethyltriethoxysilane, β-carboxyethylphenylbis(2-methoxyethoxy)silane, or N-β-(carboxymethyl)aminoethyl-γ-aminopropyltrimethoxysilane; unsaturated vinyl group-containing silanes such as vinyltrimethoxysilane, vinyltriethoxysilane, γ-methacryloyloxypropylmethyldimethoxysilane, or γ-acryloyloxypropylmethyltriethoxysilane; halogen-containing silanes such as γ-chloropropyltrimethoxysilane; and isocyanurate silanes such as tris(trimethoxysilyl)isocyanurate. In addition, derivatives obtained by modifying these compounds, such as an amino modified silyl polymer, a silylated amino polymer, an unsaturated amino silane complex, a phenylamino long chain alkyl silane, aminosilylated silicon, or a silylated polyester, can also be used as silane coupling agents.

In order to maintain adhesiveness, aminosilanes are generally preferable, and aminosilanes having a primary amino group are particularly preferable. Decrease in storage stability, which is a problem to be solved by the present invention, often occurs, when aminosilanes are added, and particularly when an aminosilane having a primary amino group is added. Accordingly, in order to sufficiently obtain the effects of the present invention, a mixture to which these aminosilane compounds are added is preferable.

The silane coupling agent used in the present invention is generally used within a range between 0.1 and 20 parts with respect to 100 parts of vinyl polymer containing a crosslinkable silyl group. It is particularly preferably used within a range between 0.5 and 10 parts. The silane coupling agent added to the curable composition of the present invention particularly significantly exhibits the effect of improving adhesiveness to various materials to be adhered, when the silane coupling agent is used in inorganic base materials such as glass, aluminum, stainless, zinc, copper or mortar, or for organic base materials such as vinyl chloride, acryl, polyester, polyethylene, polypropylene or polycarbonate, under conditions without or with primer treatments. When the silane coupling agent is used under conditions without primer treatments, the effect of improving adhesiveness to various material to be adhered is further particularly significant.

Specific examples of an agent for imparting adhesiveness other than such a silane coupling agent may include epoxy resin, phenol resin, sulfur, alkyl titanate, and aromatic polyisocyanate, although examples are not particularly limited thereto.

Agents for imparting adhesiveness to compositions, such as a silane coupling agent, may be used singly or in combination with two or more types. Adhesiveness to a material to be adhered can be improved by adding these adhesiveness-imparting agents. In order to improve adhesiveness, and particularly adhesiveness to the surface of metal such as oil pan, among the aforementioned adhesiveness-imparting agents, a silane coupling agent is preferably used within a range between 0.1 and 20 parts by weight, although it is not particularly limited.

(Plasticizer)

Various types of plasticizers are used for the curable composition of the present invention, as necessary. The type of such a plasticizer is not particularly limited. Depending on purposes such as the control of physical properties or characteristics, vinyl polymers obtained by polymerizing vinyl monomers may be used singly or in combination with two or more types. That is to say, examples of a plasticizer may include: phthalate esters such as dibutyl phthalate, diheptyl phthalate, di(2-ethylhexyl)phthalate, or butyl benzyl phthalate; nonaromatic dibasic esters such as dioctyl adipate, dioctyl sebacate, dibutyl sebacate, or isodecyl succinate; aliphatic esters such as butyl oleate or methyl acetyl ricinolate; esters of polyalkylene glycols, such as diethylene glycol dibenzoate, triethylene glycol dibenzoate, or pentaerythritol ester; phosphoric esters such as tricresyl phosphate or tributyl phosphate; trimellitic esters; polystyrenes such as polystyrene or poly-α-methylstyrene; polybutadiene, polybutene, polyisobutylene, butadiene-acrylonitrile, and polychloroprene; chlorinated paraffins; hydrocarbon oils such as alkyl diphenyl or partially hydrogenated terphenyl; process oils; polyethers including polyether polyols such as polyethylene glycol, polypropylene glycol, or polytetramethylene glycol, and derivatives obtained by converting a hydroxyl group of these polyether polyols into an ester group or an ether group; epoxy plasticizers such as epoxidated soybean oil or benzyl epoxystearate; polyester plasticizers obtained from dibasic acids such as sebacic acid, adipic acid, azelaic acid, or phthalic acid, and dihydric alcohols such as ethylene glycol, diethylene glycol, triethylene glycol, propylene glycol, or dipropyleneglycol; and acrylic plasticizers. However, these plasticizers are not necessarily required. In addition, it is also possible to mix these plasticizers when a polymer is produced.

When a plasticizer is used, the amount used is not particularly limited. It is used at an amount between 5 and 150 parts by weight, preferably between 10 and 120 parts by weight, and more preferably between 20 and 100 parts by weight, with respect to 100 parts by weight of vinyl polymer. If the amount of a plasticizer used is less than 5 parts by weight, it does not exhibit the effects as a plasticizer. In contrast, if it exceeds 150 parts by weight, the mechanical strength of a cured product becomes insufficient.

(Filler)

Various types of fillers are used for the curable composition of the present invention, as necessary. The type of a filler is not particularly limited. Examples of a filler may include: reinforcing fillers such as wood flour, pulp, cotton chip, asbestos, glass fiber, carbon fiber, mica, walnut coat powder, chaff powder, graphite, diatomaceous earth, clay, fumed silica, precipitated silica, crystalline silica, fused silica, dolomite, silicic acid anhydride, hydrous silicic acid, or carbon black; fillers such as heavy calcium carbonate, colloidal calcium carbonate, magnesium carbonate, diatomaceous earth, calcined clay, clay, talc, titanium oxide, bentonite, organic bentonite, ferric oxide, fine aluminum powder, flint powder, zinc oxide, active zinc oxide, zinc powder, or Shirasu balloon; and fiber fillers such as asbestos, glass fiber, or filament. Of these fillers, precipitated silica, fumed silica, crystalline silica, fused silica, dolomite, carbon black, calcium carbonate, titanium oxide, and talc are preferable. In particular, when a cured product with high strength is intended to be obtained using these fillers, fillers mainly selected from the group consisting of fumed silica, precipitated silica, silicic acid anhydride, hydrous silicic acid, carbon black, fine calcium carbonate formed by subjecting to surface treatment, crystalline silica, fused silica, calcined clay, clay, and active zinc oxide, can be added. Moreover, when a cured product with low strength and high elongation is intended to be obtained, fillers mainly selected from the group consisting of titanium oxide, calcium carbonate, talc, ferric oxide, zinc oxide, and Shirasu balloon, can be added. In general, when the specific surface area is small, calcium carbonate does not sufficiently exhibit the effect of improving the breaking strength, breaking elongation, adhesiveness, and weather-resistant adhesiveness of a cured product. The greater the value of the specific surface area is, the larger the effect of improving the breaking strength, breaking elongation, adhesiveness, and weather-resistant adhesiveness of a cured product that can be achieved. In addition, the surface of calcium carbonate is more preferably treated with a surface-treating agent. When such a surface-treated calcium carbonate is used, it is considered that it improves the workability of the composition of the present invention and has a greater effect of improving the adhesiveness and weather-resistance adhesiveness of the above curable composition than that of calcium carbonate the surface of which has not been treated. Examples of the aforementioned surface-treating agent may include: organic products such as fatty acid, fatty acid soap, or fatty acid ester; various types of surfactants; and various types of coupling agents such as a silane coupling agent or a titanate coupling agent. Specific examples of such a surface-treating agent may include, but are not limited to, fatty acids such as caproic acid, caprylic acid, pelargonic acid, capric acid, undecanoic acid, lauric acid, myristic acid, palmitic acid, stearic acid, behenic acid, or oleic acid; sodium or potassium salts of these fatty acids; and alkyl esters of these fatty acids. Specific examples of a surfactant may include: sulfate anionic surfactants such as polyoxyethylene alkylether sulfate, long chain alcohol sulfate, sodium salts thereof, or potassium salts thereof; and sulfonate anionic surfactants such as alkylbenzenesulfonic acid, alkylnaphthalenesulfonic acid, paraffin sulfonate, α-olefin sulfonate, alkylsulfosuccinic acid, sodium salts thereof, or potassium salts thereof. The amount of such a surface-treating agent used is preferably within a range between 0.1% and 20% by weight, and more preferably within a range between 1% and 5% by weight, with respect to 100% by weight of calcium carbonate. If the amount of a surface-treating agent used is less than 0.1% by weight, it does not sufficiently exhibit the effect of improving workability, adhesiveness, and weather-resistant adhesiveness. On the other hand, if it exceeds 20% by weight, the storage stability of the above curable composition may be decreased.

When a filler is used, such a filler added is preferably used within a range between 5 and 1,000 parts by weight, more preferably within a range between 20 and 500 parts by weight, and particularly preferably within a range between 40 and 300 parts by weight, with respect to 100 parts by weight of vinyl polymer. When the amount of a filler added is less than 5 parts by weight, it may not sufficiently exhibit the effect of improving the breaking strength, breaking elongation, adhesiveness, and weather-resistant adhesiveness of a cured product. On the other hand, when it exceeds 1,000 parts by weight, the workability of the above curable composition may be decreased. Such a filler may be used singly or in combination with two or more types.

(Agent for Regulating Physical Properties)

An agent for regulating physical properties which regulates the tensile properties of a cured product generated may be added to the curable composition of the present invention, as necessary. The type of such an agent for regulating physical properties is not particularly limited. Examples of such an agent may include: alkylalkoxysilanes such as methyltrimethoxysilane, dimethyldimethoxysilane, trimethylmethoxysilane, or n-propyltrimethoxysilane; alkoxysilanes having a functional group, such as alkylisopropenoxysilanes including dimethyldiisopropenoxysilane, methyltriisopropenoxysilane, and γ-glycidoxypropylmethyldiisopropenoxysilane, γ-glycidoxypropylmethyldimethoxysilane, γ-glycidoxypropyltrimethoxysilane, vinyltrimethoxysilane, vinyldimethylmethoxysilane, γ-aminopropyltrimethoxysilane, N-(β-aminoethyl)aminopropylmethyldimethoxysilane, γ-mercaptopropyltrimethoxysilane, or γ-mercaptopropylmethyldimethoxysilane; silicon varnishes; and polysiloxanes. Using the aforementioned physical property regulators, when the composition of the present invention is cured, the hardness thereof can be increased, or can be decreased thereby obtaining elongation. The aforementioned physical property regulators may be used singly or in combination with two or more types.

In order to enhance the activity of a condensation catalyst, a silicon compound containing no silanol group which is represented by general formula (20) indicated below may be added to the curable composition of the present invention:
R⁴⁰ₐSi(OR⁴¹)₄₋ₐ (20)
wherein each of R⁴⁰ and R⁴¹ independently represents a substituted or unsubstituted hydrocarbon group containing 1 to 20 carbon atoms; and a represents 0, 1, 2, or 3.

The type of the aforementioned silicon compound is not particularly limited. Compounds wherein, in the general formula (20), R⁴⁰ represents an aryl group containing 6 to 20 carbon atoms, such as phenyltrimethoxysilane, phenylmethyldimethoxysilane, phenyldimethylmethoxysilane, diphenyldimethoxysilane, diphenyldiethoxysilane, or tirphenylmethoxysilane, are preferable because these compounds have a great effect of accelerating the curing reaction of the composition. In particular, diphenyldimethoxysilane and diphenyldiethoxysilane are most preferable because they are inexpensive and can easily be obtained.

Such a silicon compound is added at an amount preferably between approximately 0.01 and 20 parts, and more preferably between 0.1 and 10 parts, with respect to 100 parts of vinyl polymer having at least one crosslinkable silyl group. The amount of a silicon compound added is below the above range, the effect of accelerating the curing reaction may be reduced in some cases. On the other hand, if the amount of a silicon compound added exceeds the above range, the hardness or tensile strength of a cured product may be decreased.

(Thixotropic Agent)

A thixotropic agent (anti-sagging agent) for preventing sagging thereby improving workability may be added to the curable composition of the present invention, as necessary.

The type of an anti-sagging agent is not particularly limited. Examples of such an anti-sagging agent may include: polyamide waxes; hydrogenated castor oil derivatives; and metallic soaps such as calcium stearate, aluminum stearate, or barium stearate. These thixotropic agents (anti-sagging agents) may be used singly or in combination with two or more types.

(Antioxidant)

Various types of additives may be added to the curable composition of the present invention for the purpose of regulating the physical properties of the curable composition or a cured product to be obtained, as necessary. Examples of such an additive may include a fire retardant, a hardness regulator, an antioxidant, a radical inhibitor, an ultraviolet absorber, a metal deactivator, an antiozonant, a light stabilizer, a phosphorous peroxide-decomposing agent, a lubricant, a pigment, a foaming agent, and a light-curing resin. These additives may be used singly or in combination with two or more types.

Specific examples of such an additive are described in the specifications of Japanese Patent Publication Nos. 4-69659 and 7-108928 and in Japanese Patent Laid-Open Nos. 63-254149 and 64-22904.

Polymer Blend

Other curable polymers may be blended with the curable composition of the present invention. The curing mechanism of a curable polymer to be blended may be epoxy curing, urethane curing, hydrosilylation curing, or radical curing, which are different from condensation curing with a crosslinkable silyl group contained in a polymer used as component (I) of the present invention. However, the same condensation curing is preferable.

The type of a curable polymer is not limited. Examples of such a curable polymer may include a silicon polymer, a polyisobutylene polymer, a urethane polymer, and a polyether polymer. In terms of compatibility with the polymer used as component (I) of the present invention, physical properties, or the like, a polyether polymer is preferable.

A polyether polymer having a crosslinkable functional group that is preferably blended with the curable composition of the present invention will be described below.

A polyether polymer having at least one crosslinkable silyl group may or may not contain a urethane bond or a urea bond in a main chain thereof. The main chain of such a polyether polymer is not particularly limited. Examples of such a main chain may include polyethylene oxide, polypropylene oxide, polybutylene oxide, and polyphenylene oxide. Of these, polyoxyalkylene is substantially preferable, and polypropylene oxide is substantially more preferable. It may also contain ethylene oxide, butylene oxide, phenylene oxide, or the like, as well as propylene oxide. The expression “the main chain is substantially polypropylene oxide” is used to mean that propylene oxide units make up 50% or more, preferably 70% or more, and more preferably 90% or more of repeating units that constitute the main chain. The lower the viscosity, the better the handlability that can be obtained. Thus, a polypropylene oxide polymer having a molecular weight distribution (Mw/Mn) of 1.5 or less is more preferable.

The type of a crosslinkable functional group is not particularly limited. Preferred examples may include a crosslinkable silyl group, an alkenyl group, a hydroxyl group, an amino group, a group having a polymerizable carbon-carbon double bond, and an epoxy group. A crosslinkable silyl group is particularly preferable.

The structure of a crosslinkable silyl group varies widely. It may be either identical to, or different from the structure of the polymer used as component (I) of the present invention. In addition, the number of crosslinkable functional groups contained in a polyether polymer is at least one on average. However, from the viewpoint of the curing properties of the composition, the number of crosslinkable functional groups is preferably more than 1, more preferably 1.1 to 4.0 on average, and further more preferably 1.5 to 2.5 on average. Moreover, such a crosslinkable functional group is preferably located at the terminus of a polyether polymer in terms of the rubber elasticity of a cured product. More preferably, functional groups are located at both termini of the polymer.

A method for producing a polyether polymer is not particularly limited. Previously known methods may be applied.

When a polyether polymer having at least one crosslinkable functional group that is used as component (I) of the present invention contains a urethane bond or urea bond in the main chain thereof, any production method can be applied to obtain such an organic polymer, as long as the produced polyether polymer contains at least one urethane bond or urea bond in a molecule thereof and has at least one crosslinkable functional group. The type of a crosslinkable functional group is not particularly limited. Various types of functional groups as described above can be used. Among them, a silicon-containing group represented by the following general formula (21) is preferable:
—SiYₐR⁵¹₃₋ₐ (21)
wherein R⁵¹ represents an alkyl group containing 1 to 20 carbon atoms, an aryl group containing 6 to 20 carbon atoms, an aralkyl group containing 7 to 20 carbon atoms, or a triorganosiloxy group represented by R′₃SiO—, wherein R′ represents a monovalent hydrocarbon group containing 1 to 20 carbon atoms, and three R′s may be identical to or different from one another, and when two or more R¹s exist, these may be identical to or different from one another; Y represents a hydroxyl group or a hydrolyzable group, and when two or more Ys exist, these may be identical to or different from one another; and a represents 0, 1, 2, or 3. An example of a method for industrially easily produce a polyether polymer may be a method of producing a polyether polymer, which comprises: allowing an excessive polyisocyanate compound (E) to react with a hydroxyl group located at the terminus of an oxyalkylene polymer (D) having the hydroxyl group at the terminus, so as to obtain a polymer having an isocyanate group at the terminus of a polyurethane main chain (F); and thereafter or at the same time, allowing the W group of a silicon compound (G) represented by general formula (22) indicated below to react with the above isocyanate group:
W—R⁵²—SiYₐR⁵¹₃₋ₐ (22)
wherein R⁵¹, Y, and a have the same meanings as described above, R⁵² represents a substituted or unsubstituted divalent organic group containing 1 to 20 carbon atoms; and W represents an active hydrogen-containing group selected from the group consisting of a hydroxyl group, a carboxyl group, a mercapto group, and an amino group (primary or secondary). Another example may be a method of allowing a hydrolyzable silicon-containing isocyanate compound (H) represented by general formula (23) indicated below to react with the oxyalkylene polymer (D) having a hydroxyl group at the terminus:
O═C═N—R⁵²—SiYₐR⁵¹₃₋ₐ (23)
wherein R⁵¹, R⁵², Y, and a have the same meanings as described above.

A method for producing the oxyalkylene polymer (D) is not particularly limited, and any type of oxyalkylene polymer can be used. A preferred example is an oxyalkylene polymer containing at the terminus thereof at least 0.7 hydroxyl groups per molecular terminus on average of all the molecules. Specific examples of such an oxyalkylene polymer may include: an oxyalkylene polymer produced using a conventional alkali metal catalyst; and an oxyalkylene polymer produced by allowing alkylene oxide to react with a polyhydroxy compound having at least two hydroxyl groups used as an initiator in the presence of a composite metal-cyanide complex (C) or secium.

Among the aforementioned methods, the use of the composite metal-cyanide complex (C) enables the production of an oxyalkylene polymer (D) having a lower unsaturation degree, higher molecular weight, narrower Mw/Mn, lower viscosity, higher acid resistance, and higher weather resistance, than those of an oxyalkylene polymer produced by the conventional alkali metal catalyst. Thus, the use of the composite metal-cyanide complex is preferable.

A complex having zinc hexacyanocobaltate as a main component is preferably used as such a composite metal-cyanide complex (C), and its ether and/or alcohol complex is preferable. The composition described in Japanese Patent Publication No. 46-27250 can substantially be used. Preferred examples of such ether may include glimes such as tetrahydrofuran, glime, or diglime. Of these, tetrahydrofuran and glime are more preferable because the oxyalkylene polymer (D) having narrow Mw/Mn and a low unsaturation degree can be obtained using these substances. As alcohol, t-butanol described in Japanese Patent Laid-Open No. 4-145123 is preferable because the oxyalkylene polymer (D) having a low unsaturation degree can be obtained using this substance.

In order to obtain a polymer with a high molecular weight as a result of the reaction of the oxyalkylene polymer (D) with the polyisocyanate compound (E), and also to enhance the rate of introducing a silyl group due to the reaction of the oxyalkylene polymer (D) with the hydrolyzable silicon-containing isocyanate compound (H), the number of hydroxyl groups contained in the oxyalkylene polymer (D) is preferably 1.6 or more, and particularly preferably between 1.8 and 4, per molecule on average of all the molecules. In order to prevent the occurrence of gelation during the reaction with the polyisocyanate compound (E), the number of hydroxyl groups is further more preferable between 1.8 and 3. In addition, the oxyalkylene polymer (D) having two or more hydroxyl groups can be produced using an initiator having three or more functional groups instead of a part of or the entire initiator having two functional groups. It is also possible to obtain the oxyalkylene polymer (D) having 1.8 to 3 hydroxyl groups per molecule on average of all the molecules by mixing the obtained oxyalkylene polymer having two or more functional groups with an oxyalkylene polymer having two or less functional groups.

Specific examples of such an oxyalkylene polymer (D) may include a polyoxyethylene compound, a polyoxypropylene compound, a polyoxybutylene compound, a polyoxyhexylene compound, a polyoxytetramethylene compound, and/or a copolymer thereof.

Particularly preferred examples of such an oxyalkylene polymer (D) may be polyoxypropylene diol, polyoxypropylene triol, polyoxypropylene tetraol, a copolymer of these polymers and ethylene oxide, and a mixture thereof.

In order to facilitate the reaction of the oxyalkylene polymer (D) with the polyisocyanate compound (E) or the hydrolyzable silicon-containing isocyanate compound (H), it is preferable that an oxyalkylene polymer be copolymerized with ethylene oxide, so that a hydroxyl group at the terminus thereof becomes primary.

The number average molecular weight of the oxyalkylene polymer (D) can be 1,000 or greater. If it is less than 4,000, the number of urethane bonds introduced into the polyurethane main chain (F) increases, and the viscosity becomes relatively high. Thus, the oxyalkylene polymer (D) having a number average molecular weight of 4,000 or greater is preferably used.

Any polyisocyanate compound can be used as such a polyisocyanate compound (E) used to obtain the polyurethane main chain (F) in the present invention.

The number of isocyanate groups contained in the polyisocyanate compound (E) is preferably between 2 and 5 per molecule on average. It is more preferably between 2 and 3 in terms of easy procurement. Moreover, in order to prevent the occurrence of gelation during the reaction of the polyisocyanate compound (E) with the oxyalkylene polymer (D), the number of isocyanate groups is most preferably 2.

Specific examples of such a polyisocyanate compound (E) may include tolylene diisocyanate (TDI), methylene diisocyanate (MDI), xylene diisocyanate (XDI), isophorone diisocyanate (IPDI), hexamethylene diisocyanate (HMDI), and tetramethylene diisocyanate (TMDI). Moreover, their urethodione derivatives, isocyanurate derivatives, cyanurate derivatives, and carbodiimide derivatives can also be used.

Specific examples of the silicon compound (G) represented by the general formula (22) that is used to introduce the silicon-containing group represented by the general formula (21) into a molecule of a polyether polymer may include: amino group-substituted alkoxysilanes such as γ-aminopropyltrimethoxysilane, γ-aminopropyltriethoxysilane, γ-aminopropylmethyldimethoxysilane, N-(β-aminoethyl)-γ-aminopropyltrimethoxysilane, N-(β-aminoethyl)-γ-aminopropyltriethoxysilane, N-(β-aminoethyl)-γ-aminopropylmethyldimethoxysilane, 1,3-diaminoisopropyltrimethoxysilane; γ-hydroxypropyltrimethoxysilane; and γ-mercaptopropyltrimethoxysilane.

Specific examples of the silicon group-containing isocyanate compound (H) represented by the general formula (23) that is used to introduce the silicon-containing group represented by the general formula (21) into a molecule of a polyether polymer may include γ-trimethoxysilylpropyl isocyanate, γ-triethoxysilylpropyl isocyanate, γ-methyldimethoxysilylpropyl isocyanate, and γ-methyldiethoxysilylpropyl isocyanate.

Catalysts can be used for the reaction of a hydroxyl group contained in the oxyalkylene polymer (D) with an isocyanate group, and for the reaction of a W group contained in a silicon compound with an isocyanate group. However, when the storage stability of the obtained polyether polymer deteriorates, these reactions are preferably carried out in the absence of a catalyst. When a catalyst is used, any known catalysts can be used, as long as such catalysts catalyze the reaction between a hydroxyl group and an isocyanate group.

Among the polyether polymers having at least one crosslinkable functional group of the present invention, a polyether polymer containing a urethane bond or urea bond in a main chain thereof preferably has a number average molecular weight of 7,500 or greater. An organic polymer having a number average molecular weight between 7,500 and 25,000 is particularly preferably used. When the number average molecular weight of a polyether polymer is less than 7,500, the obtained cured product is hard, having low elongation. In contrast, when the number average molecular weight exceeds 25,000, there are no problems regarding the flexibility and elongation of the obtained cured product. However, the adhesiveness of the above polymer itself significantly decreases, resulting in low practicality. Thus, the number average molecular weight is particularly preferably between 8,000 and 20,000 in terms of viscosity.

The mixing ratio of the vinyl polymer (I) to the polyether polymer is preferably within a range between 100/1 and 1/100, more preferably within a range between 100/5 and 5/100, and further more preferably within a range between 100/10 and 10/100, at weight ratio. If the ratio of the vinyl polymer (I) blended is small, there is a case where excellent weather resistance is hardly exhibited.

Storage Stability

With regard to compositions similar to the curable composition of the present invention, it is not preferable that the curing rate after a long-term storage is largely changed from that before storage. For example, when the composition is used as a sealant, it is subjected to operations of adjusting the surface form after application to a joint or of applying a finishing material or coating material. Thus, a change in the time when the surface is cured, that is, what is called skinning time, impairs such operations.

Storage conditions for confirming the effects of the present invention are not particularly limited. In general, a change in storage hardly occurs at a low temperature. The storage temperature becomes considerably high in summer. In order to quickly evaluate storage stability, the temperature is preferably set between a room temperature and 80° C. The evaluation was carried out at 50° C. in the examples of the present invention.

<<Second Invention>>

The second aspect of the present invention relates to a sealant, a liquid gasket, and an adhesive, for which the curable composition in the first aspect of the present invention is used. The curable composition in the first aspect of the present invention has improved in terms of storage stability. Thus, it is preferably used for a sealant, a liquid gasket, and an adhesive.

More detailed uses regarding the aforementioned use of the curable composition of the present invention, and other uses, are not limited. The curable composition of the present invention can be used for a variety of purposes, which include: electric and electronic components (sealants used for the circuits or substrates of heavy electric components, light electric components, and electric or electronic devices (sealant used for a refrigerator, a freezer, a washing machine, a gas meter, a microwave, a steam iron, or a ground fault breaker), potting materials (potting of a transformer high pressure circuit, a printed circuit board, a transformer for high voltage equipped with a variable resistor, an electrical insulating component, a semiconductive component, a conductive component, a solar battery, or a flyback transformer for television), coating materials (coating of a circuit element of a thick-film resistor for high voltage or hybrid IC; HIC; an electrical insulating component; a semiconductive component; a conductive component; a module; a printed circuit; a ceramic substrate; a buffer material used for diode, transistors, or bonding wires; a semiconductive element; or an optical fiber used for optical communication); or adhesives (adhesion of a cathode ray tube wedge, a neck, an electrical insulating component, a semiconductive component, or a conducive component); or a repairing material for coating electric wires; an insulation sealant for electric wire-jointing components; a roll for office automation devices; a vibration dampener; or gel or condenser), automotive parts (sealants used for the gasket, electrical components, or oil filter of an automotive engine; potting materials used for igniter HIC or automotive hybrid IC; coating materials used for an automotive body, an automotive window, or an engine control substrate; or adhesives used for the gasket of an oil pan, the gasket of a timing belt cover, molding, a headlamp lens, a sunroof seal, or a mirror; a fuel injector, a fuel heater, an air damper, a pressure sensor, an oil cooler of a resin tank for heat exchanger, a variable compression ratio engine, a cylinder device, a regulator for compressed natural gas, a pressure vessel, a fuel-supplying system of a direct-injection internal combustion engine, or an O-ring for high pressure pump), watercrafts (sealants used for a wire connecting or dividing box, an electrical system component, or an electric wire); or adhesives used for an electric wire or glass), aircrafts, railroad vehicles, civil engineering and construction (sealants for construction materials, which are used for a joint used in the glass screen method for commercial buildings, a joint between sash and glass, inner packaging joints in toilet, lavatory, or showcase, a joint around bathtub, an expansion joint of the outer wall of a prefabricated house, or a sealant used for a joint of a sizing board; sealants used for double-grazed glass; sealants for engineering, which are used for repairing roads; coating agents and adhesives used for metal, glass, stone, slate, concrete, or tile; or adhesive sheets, waterproof sheets, or vibration-proof sheets), medical products (sealants used for a medical rubber stopper, a syringe gasket, or a rubber stopper for decompressed blood vessel), or leisure items (swimming materials used for a swimming cap, a diving mask, or an earplug; or gel buffer materials used for sports shoes or a baseball glove), etc. Because of its properties, the curable composition of the present invention is preferably applied to liquid sealing agents, which are used for automotive parts, O-rings, electric components, various types of mechanical components, etc., but the usage thereof is not particularly limited thereto.

<<Third Invention>>

The third aspect of the present invention relates to a polymer, which has at least one crosslinkable functional group at the terminus and also has a vinyl polymer as a main chain thereof, wherein 2% to 80% by weight of monomers based on the total monomers constituting the main chain is methyl acrylate. Preferably, 5% to 50% by weight of monomers based on the total monomers constituting the main chain is methyl acrylate. More preferably, 5% to 20% by weight of monomers based on the total monomers constituting the main chain is methyl acrylate.

In another embodiment, the third aspect of the present invention relates to a polymer, which has at least one crosslinkable functional group at the terminus and also has a vinyl polymer as a main chain thereof, wherein 2% to 50% by weight of monomers based on the total monomers constituting the main chain is methyl methacrylate. Preferably, 2% to 20% by weight of monomers based on the total monomers constituting the main chain is methyl methacrylate.

The vinyl polymer as a main chain of the aforementioned polymer is preferably a (meth)acrylic polymer.

A method for polymerizing these polymers is not limited. A polymerization method described in the first aspect of the present invention is preferable.

These polymers are suitably used as component (I) of the curable composition in the first aspect of the present invention. They exhibit the effect of improving strength in the mechanical properties of a cured product, or the like.

The crosslinkable functional group of the present invention may preferably be a crosslinkable silyl group that is component (I) of the curable composition in the first aspect of the present invention, an alkenyl group, a (meth)acryloyl group, or a hydroxyl group.

A method for introducing these functional groups into a polymer may be the same as described in the first aspect of the present invention, but is not limited thereto. A method for introducing a (meth)acryloyl group into a polymer is described in WO9965963, for example.

<<Fourth Invention>>

The fourth aspect of the present invention relates to a curable composition comprising, as an essential component, the polymer in the third aspect of the present invention.

When the above curable composition comprises, as an essential component, a polymer having, at the terminus, a crosslinkable silyl group the same as in the component (I) of the curable composition in the first aspect of the present invention, the same conditions as those described in the first aspect of the present invention are applied.

With regard to crosslinkable functional groups other than the crosslinkable silyl group also, the similar mixed materials may be used.

Composition Comprising Polymer Having Alkenyl Group at the Terminus

A curable composition comprising, as an essential component, a polymer having an alkenyl group at the terminus will be described below.

When a vinyl polymer having an alkenyl group at the terminus is used as a curable composition, it may be used singly, or in combination with a curing agent. A curable composition comprising the polymer (component A) of the third invention and a hydrosilyl group-containing compound (component B) is more preferable. The type of a hydrosilyl group-containing compound used as component B is not particularly limited. Various types of compounds can be used. That is to say, chain polysiloxanes represented by the following general formulae (24) and (25);
R⁶⁰₃SiO—[Si(R⁶⁰)₂O]ₐ—[Si(H)(R⁶¹)O]_{b}—[Si(R⁶¹)(R⁶²)O]_{c}—SiR⁶⁰₃ (24)
HR⁶⁰₂SiO—[Si(R⁶⁰)₂O]ₐ—[Si(H)(R⁶¹)O]_{b}—[Si(R⁶¹)(R⁶²)O]_{c}—SiR⁶⁰₂H (25)
wherein each of R⁶⁰ and R⁶¹ represents an alkyl group containing 1 to 6 carbon atoms or a phenyl group; R⁶² represents an alkyl group containing 1 to 10 carbon atoms or aralkyl group; a, b, and c represent integers, each of which satisfy 0≦a≦10, 2≦b≦100, and 0≦c≦100, or
a cyclic siloxane represented by the general formula (26): 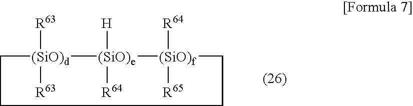
wherein each of R⁶³ and R⁶⁴ represents an alkyl group containing 1 to 6 carbon atoms or a phenyl group; R⁶⁵ represents an alkyl group containing 1 to 10 carbon atoms or aralkyl group; and d, e, and f represent integers, which satisfy 0≦d≦8, 2≦e≦10, and 0≦f≦8, wherein 3≦d+e+f≦10, can be used. These siloxanes may be used singly or in combination with two or more types. Of these siloxanes, chain siloxanes represented by general formulae (27) and (28) indicated below and cyclic siloxanes represented by general formulae (29) and (30) indicated below, which have a phenyl group, are preferably from the viewpoint of compatibility with a (meth)acrylic polymer.
(CH₃)₃SiO—[Si(H)(CH₃)O]_{g}—[Si(C₆H₅)₂O]ₕ—Si(CH₃)₃ (27)
(CH₃)₃SiO—[Si(H)(CH₃)O]_{g}—[Si(CH₃){CH₂C(H)(R⁶⁶)C₆H₅}O]ₕ—Si(CH₃)₃ (28)
wherein R⁶⁶ represents hydrogen or a methyl group; g and h represent integers, which satisfy 2≦g≦100 and 0≦h≦100; and C₆H₅ represents a phenyl group. 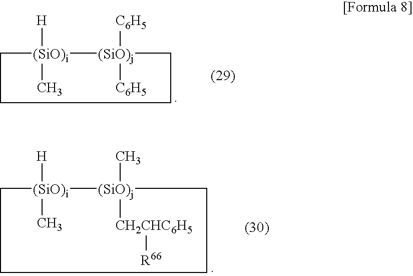
wherein R⁶⁶ represents hydrogen or a methyl group; i and j represent integers, which satisfy 2≦i≦10 and 0≦j≦8, wherein i and j also satisfy 3≦i+j≦10; and C₆H₅ represents a phenyl group.

As a hydrosilyl group-containing compound used as component (B), a compound obtained by an addition reaction of adding the hydrosilyl group-containing compounds represented by the general formulae (22) to (28) to a low molecular weight compound having two or more alkenyl groups in a molecule thereof, such that several hydrosilyl groups remain after the reaction, can also be used. Various types of compounds can be used as a compound having two or more alkenyl groups in a molecule thereof. Examples of such a compound may include: hydrocarbon compounds such as 1,4-pentadiene, 1,5-hexadiene, 1,6-heptadiene, 1,7-octadiene, 1,8-nonadiene, or 1-9 decadiene; ether compounds such as O,O′-diallylbisphenol A or 3,3′-diallylbisphenol A; ester compounds such as diallyl phthalate, diallyl isophthalate, triallyl trimellitate, or tetraallyl pyromellitate; and carbonate compounds such as diethylene glycol diallyl carbonate.

The aforementioned compound containing an alkenyl group is slowly added dropwise to an excessive amount of hydrosilyl group-containing compound represented by each of the formulae (16) to (22) in the presence of a hydrosilylation catalyst, so as to obtain the above described hydrosilyl group-containing compound used as component (B). Taking into consideration easy procurement of raw materials, easy elimination of excessive siloxane, and compatibility with the polymer used as component (A), among the thus obtained compounds, the following compounds are preferable.

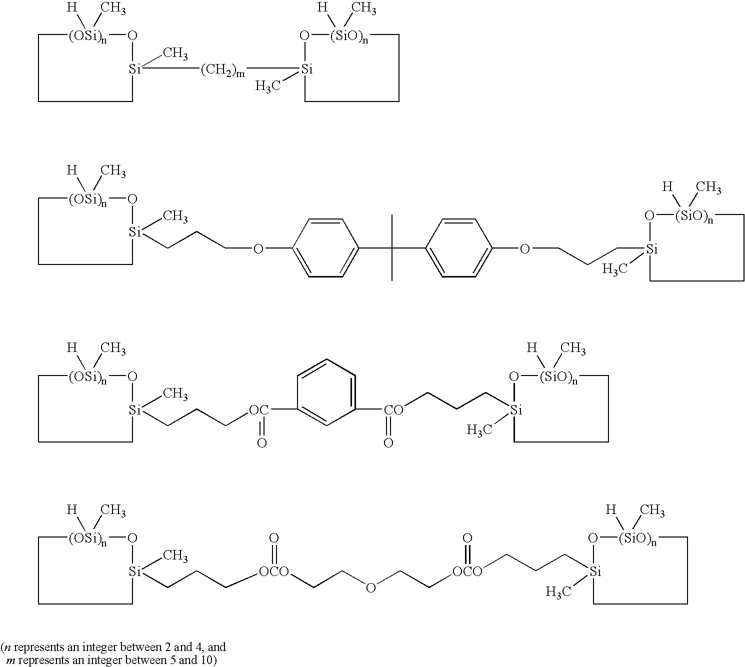

The polymer of the third invention (component A) can be mixed with the hydrosilyl group-containing compound (component B) at any given ratio. In terms of curing properties, the molar ratio of an alkenyl group to a hydrosilyl group is preferably between 5 and 0.2, and particularly preferably between 2.5 and 0.4. If the molar ratio is 5 or greater, only a cured product with low strength, which is insufficient in hardness and is sticky, can be obtained. On the other hand, if the molar ratio is less than 0.2, active hydrosilyl groups remain at a large amount in a cured product even after curing, and cracks or voids are thereby generated. As a result, a homogeneous cured product with certain strength cannot be obtained. The curing reaction is promoted by mixing two components and heating it. In order to conduct the reaction more rapidly, a hydrosilylation catalyst is added. Examples of such a hydrosilylation catalyst may include: radical initiators such as organic peroxides or azo compounds; and transition metal catalysts.

The type of a radical initiator is not particularly limited, and various types of radical initiators can be used. Examples of such a radical initiator may include: dialkyl peroxides such as di-t-butyl peroxide, 2,5-dimethyl-2,5-di(t-butylperoxy)hexane, 2,5-dimethyl-2,5-di(t-butylperoxy)₃-hexyne, dicumyl peroxide, t-butyl cumyl peroxide, or α,α′-bis(t-butylperoxy)isopropylbenzene; diacyl peroxides such as benzoyl peroxide, p-chlorobenzoyl peroxide, m-chlorobenzoyl peroxide, 2,4-dichlorobenzoyl peroxide, or lauroyl peroxide; peroxy esters such as t-butyl perbenzoate; peroxydicarbonates such as diisopropyl peroxydicarbonate or 2-ethyl hexyl peroxydicarbonate; and peroxyketals such as 1,1-di(t-butylperoxy)cyclohexane or 1,1-di(t-butylperoxy)-3,3,5-trimethylcyclohexane.

Examples of a transition metal catalyst may include: a platinum simplex; a product formed by dispersing a platinum solid into a carrier such as alumina, silica, or carbon black; chloroplatinic acid; a complex of chloroplatinic acid with alcohol, aldehyde, ketone, or the like; a platinum-olefin complex; and a platinum (0)-divinyltetramethyldisiloxane complex. Examples of a catalyst other than a platinum compound may include RhCl(PPh₃)₃, RhCl₃, RuCl₃, IrCl₃, FeCl₃, AlCl₃, PdCl₂-H₂O, NiCl₂, and TiCl₄. These catalysts may be used singly or in combination with two or more types. The amount of a catalyst used is not particularly limited. Such a catalyst is used within a range between 10⁻¹ and 10⁻⁸ moles, and preferably within a range between 10⁻³ and 10⁻⁶ moles, with respect to 1 mole of alkenyl group used as component (A). If the amount of catalyst used is less than 10⁻⁸ moles, the curing reaction does not sufficiently progress. In addition, since a hydrosilylation catalyst is expensive, it is preferable not to use more than 10⁻¹ moles. Curing conditions are not particularly limited. It is preferable to carry out the curing reaction at a temperature generally between 0° C. and 200° C. and preferably between 30° C. and 150° C. for approximately 10 seconds to 24 hours. In particular, at a high temperature between 80° C. and 150° C., some cured products can be cured in a short time between approximately 10 seconds to 1 hour. The properties of such a cured product depend on the main chain skeletons of the polymer used as component (A) or the curing agent used as component (B), or the molecular weights thereof. Various types of cured products ranging from a rubber product to a resin product can be produced.

The use of the curable composition of the present invention is not limited. The curable composition can preferably be used for various purposes, which are described in the second invention.

<<Fifth Invention>>

The fifth aspect of the present invention relates to a curable composition with improved storage stability, which comprises the following two components as essential components:

a vinyl polymer (I) having at least one crosslinkable silyl group represented by the above described general formula (1); and

a compound (II) having a methyl ester group other than the compound (I).

<Component (I) in the Fifth Aspect of the Present Invention>

The crosslinkable silyl group represented by the general formula (1) is identical to the component (I) of the curable composition in the first aspect of the present invention. The number of crosslinkable functional groups is also the same as that of the component (I) of the curable composition in the first aspect of the present invention.

In addition, the crosslinkable silyl group represented by the general formula (1) is preferably located at the terminus of a vinyl polymer.

Vinyl Monomer Constituting Vinyl Polymer

In terms of the physical properties of a product to be obtained or the like, a vinyl monomer constituting the main chain of a vinyl polymer preferably comprises, as main components, alkyl (meth)acrylate and/or alkoxyalkyl (meth)acrylate.

Examples of alkyl (meth)acrylate may include ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, and stearyl (meth)acrylate. Of these, ethyl acrylate, butyl acrylate, isobutyl acrylate, and 2-ethylhexyl acrylate are preferable. Ethyl acrylate and butyl acrylate are particularly preferable.

Examples of alkoxyalkyl (meth)acrylate may include 2-methoxyethyl (meth)acrylate, 2-ethoxyethyl (meth)acrylate, and 3-methoxybutyl (meth)acrylate. Of these, 2-methoxyethyl acrylate and 2-ethoxyethyl (meth)acrylate are particularly preferable.

In order to control physical properties, in addition to alkyl (meth)acrylate and alkoxyalkyl (meth)acrylate, the following vinyl monomers may also be copolymerized. Examples of a vinyl monomer capable of being copolymerized may include: (meth)acrylic monomers such as (meth)acrylic acid, phenyl (meth)acrylate, toluyl (meth)acrylate, benzyl (meth)acrylate, 2-hydroxyethyl (meth)acrylate, 2-hydroxypropyl (meth)acrylate, glycidyl (meth)acrylate, 2-aminoethyl (meth)acrylate, γ-(methacryloyloxypropyl)trimethoxysilane, an ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, or 2-perfluorohexadecylethyl (meth)acrylate; styrene monomers such as styrene, vinyltoluene, α-methylstyrene, chlorstyrene, or styrene sulfonate and a salt thereof; fluorine-containing vinyl monomers such as perfluoroethylene, perfluoropropylene, or vinylidene fluoride; silicon-containing vinyl monomers such as vinyltrimethoxysilane or vinyltriethoxysilane; maleic anhydride, maleic acid, and a monoalkyl ester and a dialkyl ester of maleic acid; fumaric acid, and a monoalkyl ester and a dialkyl ester of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide, or cyclohexylmaleimide; nitrile-containing vinyl monomers such as acrylonitrile or methacrylonitrile; amide group-containing vinyl monomers such as acrylamide or methacrylamide; vinyl esters such as vinyl acetate, vinyl propionate, vinyl pivalate, vinyl benzoate, or vinyl cinnamate; alkenes such as ethylene or propylene; conjugated dienes such as butadiene or isoprene; and vinyl chloride, vinylidene chloride, allyl chloride, and allyl alcohol.

Properties such as oil resistance, heat resistance, or cold resistance can be controlled by changing the composition ratio of alkyl (meth)acrylate and/or alkoxyalkyl (meth)acrylate, which are the main constituent units of a vinyl polymer.

For example, in order to obtain a cured product having a well balance of rubber elasticity, oil resistance, heat resistance, cold resistance, surface tackiness, and surface staining properties, a vinyl polymer preferably comprises alkyl acrylate at a weight ratio between 60% and 80% based on the total weight of vinyl monomers constituting the vinyl polymer and alkoxyalkyl acrylate at a weight ratio between 20% and 40% based on the total weight of vinyl monomers constituting the vinyl polymer. In this case, a vinyl polymer, which comprises ethyl acrylate at a weight ratio between 30% and 50% based on the total weight of vinyl monomers, butyl acrylate at a weight ratio between 20% and 40% based on the total weight of vinyl monomers, and 2-methoxyethyl acrylate at a weight ratio between 20% and 40% based on the total weight of vinyl monomers, is well balanced. A vinyl polymer, which comprises ethyl acrylate at a weight ratio between 50% and 80%, butyl acrylate at a weight ratio between 0% and 20%, and 2-methoxyethyl acrylate at a weight ratio between 20% and 40%, is more excellent in terms of oil resistance. In addition, a vinyl polymer, which comprises ethyl acrylate at a weight ratio between 0% and 30%, butyl acrylate at a weight ratio between 40% and 80%, and 2-methoxyethyl acrylate at a weight ratio between 20% and 40%, is more excellent in terms of cold resistance.

When oil resistance and cold resistance are particularly emphasized, a vinyl polymer preferably comprises alkyl acrylate at a weight ratio between 20% and 60% based on the total weight of vinyl monomers constituting the vinyl polymer, and alkoxyalkyl acrylate at a weight ratio between 40% and 80% based on the total weight of vinyl monomers constituting the vinyl polymer. In this case, when a vinyl polymer comprises ethyl acrylate and butyl acrylate whose total weight is between 20% and 60% at a weight ratio based on the total vinyl monomers constituting the vinyl polymer, and 2-methoxyethyl acrylate at a weight ratio between 40% and 80% based on the total vinyl monomers constituting the vinyl polymer, it is more excellent in terms of oil resistance and cold resistance. Thus, such a vinyl polymer is more preferable. When a vinyl polymer comprises ethyl acrylate at a weight ratio between 10% and 30% based on the total weight of vinyl monomers constituting the vinyl polymer, butyl acrylate at a weight ratio between 10% and 30% based on the total weight of vinyl monomers constituting the vinyl polymer, and 2-methoxyethyl acrylate at a weight ratio between 40% and 80% based on the total weight of vinyl monomers constituting the vinyl polymer, it is excellent in terms of oil resistance and cold resistance. When a vinyl polymer comprises ethyl acrylate at a weight ratio between 0% and 10% based on the total weight of vinyl monomers constituting the vinyl polymer, butyl acrylate at a weight ratio between 30% and 60% based on the total weight of vinyl monomers constituting the vinyl polymer, and 2-methoxyethyl acrylate at a weight ratio between 40% and 80% based on the total weight of vinyl monomers constituting the vinyl polymer, it is particularly excellent in terms of cold resistance. When a vinyl polymer comprises ethyl acrylate at a weight ratio between 30% and 60% based on the total weight of vinyl monomers constituting the vinyl polymer, butyl acrylate at a weight ratio between 0% and 10% based on the total weight of vinyl monomers constituting the vinyl polymer, and 2-methoxyethyl acrylate at a weight ratio between 40% and 80% based on the total weight of vinyl monomers constituting the vinyl polymer, it is excellent in terms of oil resistance and cold resistance.

When oil resistance and heat resistance are particularly emphasized, a vinyl polymer preferably comprises alkyl acrylate at a weight ratio between 80% and 100% based on the total weight of vinyl monomers constituting the vinyl polymer, and alkoxyalkyl acrylate at a weight ratio between 0% and 20% based on the total weight of vinyl monomers constituting the vinyl polymer. In this case, when a vinyl polymer comprises ethyl acrylate at a weight ratio between 40% and 60% based on the total weight of vinyl monomers constituting the vinyl polymer, butyl acrylate at a weight ratio between 40% and 60% based on the total weight of vinyl monomers constituting the vinyl polymer, and 2-methoxyethyl acrylate at a weight ratio between 1% and 20% based on the total vinyl monomers constituting the vinyl polymer, it is excellent in terms of rubber elasticity, as well as oil resistance and heat resistance. When a vinyl polymer comprises ethyl acrylate at a weight ratio between 60% and 100% based on the total weight of vinyl monomers constituting the vinyl polymer, butyl acrylate at a weight ratio between 0% and 40% based on the total weight of vinyl monomers constituting the vinyl polymer, and 2-methoxyethyl acrylate at a weight ratio between 0% and 20% based on the total weight of vinyl monomers constituting the vinyl polymer, it is excellent in terms of oil resistance, heat resistance, surface tackiness, and surface staining properties. When a vinyl polymer comprises ethyl acrylate at a weight ratio between 0% and 40% based on the total weight of vinyl monomers constituting the vinyl polymer, butyl acrylate at a weight ratio between 60% and 100% based on the total weight of vinyl monomers constituting the vinyl polymer, and 2-methoxyethyl acrylate at a weight ratio between 0% and 20% based on the total weight of vinyl monomers constituting the vinyl polymer, it is excellent in terms of oil resistance, heat resistance, and rubber elasticity.

The molecular weight and molecular weight distribution of the vinyl polymer are the same as those of component (I) of the curable composition in the first aspect of the present invention.

The method for polymerizing the vinyl polymer is not limited, but the same method as applied to component (I) of the curable composition in the first aspect of the present invention is applied.

The method for introducing a crosslinkable silyl group into the vinyl polymer is not limited either, but the same method as applied to component (I) of the curable composition in the first aspect of the present invention is applied.

Compound (II) Having Methyl Ester Group Other than Compound (I)

The compound having a methyl ester group other than the compound (I) in the fifth aspect of the present invention is not particularly limited. Either a compound other than a polymer, or a polymer can be used.

The structure of the compound having a methyl ester group other than the compound (I) is not particularly limited. The carbon atom at the α-position of the methyl ester group which is contained in the above compound containing a methyl ester group other than the compound (I) is preferably primary or secondary, since the compound with such a structure has a great effect of suppressing delay in curing.

When the compound having a methyl ester group other than the compound (I) is not a polymer, it is preferably a dimethyl ester of dicarboxylic acid, but is not limited thereto. This is because it exhibits high effects because of a high methyl ester concentration per weight of the compound and also because volatilization hardly occurs.

When the compound having a methyl ester group other than the compound (I) is not a polymer, such a compound is not limited to, but is preferably selected from the group consisting of: dimethyl malonate, dimethyl succinate, dimethyl glutarate, dimethyl adipate, dimethyl sebacate, methyl acetate, methyl propionate, methyl butyrate, methyl valerate, methyl caprylate, methyl caprate, methyl laurate, methyl myristate, methyl palmitate, methyl stearate, methyl oleate, methyl ricinoleate, and coconut fatty acid methyl ester.

These compounds may be used either singly or in combination.

When the compound having a methyl ester group other than the compound (I) is a polymer, the structure thereof is not particularly limited. A polymer containing a monomer having a methylester group as a constituent unit is preferable. The monomer having a methyl ester group is not particularly limited, but it is preferably methyl acrylate.

When the compound having a methyl ester group other than the compound (I) is a copolymer containing a monomer having a methyl ester group as a constituent, with regard to ester groups contained in monomers other than the monomer having a methyl ester group, alkoxy groups thereof are not particularly limited. However, ester groups, which are primary and contain 5 or more carbon atoms, preferably make up 80% or less at a molar ratio with respect to the methyl ester groups.

When the compound having a methyl ester group other than the compound (I) is a copolymer containing a monomer having a methyl ester group as a constituent, with regard to ester groups contained in monomers other than the monomer having a methyl ester group, alkoxy groups thereof are not particularly limited. However, ester groups, which are primary and contain 2 to 4 carbon atoms, preferably make up 400% or less at a molar ratio with respect to the methyl ester groups.

Delay in curing, which is a problem to be solved by the present patent, is largely influenced by ester groups other than methyl ester groups. The larger the molecular weight of alkoxy groups of the ester groups, the greater the influence that can be obtained. It is likely that the effect of suppressing delay in curing obtained by addition of the compound having a methyl ester group other than the compound (I) is changed due to the ratio of methyl ester groups to other ester groups. As the ratio of such methyl ester groups increases, the greater effect can be obtained. Even if the compound having a methyl ester group is added, when the ratio of such methyl ester groups is low, the effect cannot sufficiently be exhibited.

Accordingly, the additive amount of the compound (II) in the present invention having methyl ester group other than the compound (I) is not limited, but in order to exhibit the effect of suppressing delay in curing, the additive amount is preferably large. However, if it is too large, the viscosity of the mixture or the physical properties of the cured product may be deteriorated. Thus, it is preferable to add an appropriate amount of the compound (II) depending on the purpose.

When the compound having a methyl ester group is a polymer, a method for synthesizing such a polymer is not limited. Various polymerization methods that have already been known are used. When the monomer having a methyl ester group is a radical polymerizable monomer, in order to synthesize such a monomer, various types of radical polymerization methods may be applied. Examples of representative methods may include: general free radical polymerization; free radical polymerization using a chain transfer agent; high-temperature high-pressure continuous polymerization (described in National Publication of International Patent Application No. 57-502171, Japanese Patent Laid-Open Nos. 59-6207 and 60-215007, National Publication of International Patent Application No. 10-511992, etc.); and atom transfer radical polymerization described in the section regarding a method of synthesizing the polymer used as component (I) of the present patent.

<Curable Composition>

Similar substances to those added to the curable composition in the first aspect of the present invention can be added to the curable composition in the fifth aspect of the present invention.

Mixed Material

For a curable composition comprising a polymer having a crosslinkable silyl group, a curing catalyst or a silane coupling agent is often mixed. Decrease in storage stability, which is a problem to be solved by the fifth aspect of the present invention, often occurs in a case where such a curing catalyst or silane coupling agent is mixed. Thus, in order to sufficiently obtain the effects of the present invention, a mixture containing these components is preferable. In addition, various types of additives may be added, depending on physical properties of interest.

Component (III): Condensation Catalyst

The condensation catalyst used as component (III) in the fifth aspect of the present invention is similar to the condensation catalyst used as component (II) in the first aspect of the present invention.

Component (IV): Amine Compound

The amine compound used as component (IV) in the fifth aspect of the present invention is similar to the amine compound used as component (III) in the first aspect of the present invention.

Silane Coupling Agent

The silane coupling agent that is one of the amine compounds used as component (IV) in the fifth aspect of the present invention is similar to the silane coupling agent that is one of amine compounds used as component (III) in the first aspect of the present invention.

Mixed materials other than such a silane coupling agent are not particularly limited. Examples of other mixed materials may include epoxy resin, phenol resin, sulfur, alkyl titanate, and aromatic polyisocyanate.

Agents for imparting adhesiveness to compositions, such as a silane coupling agent, may be used singly or in combination with two or more types. Adhesiveness to a material to be adhered can be improved by adding these adhesiveness-imparting agents. In order to improve adhesiveness, and particularly adhesiveness to the surface of metal such as oil pan, among the aforementioned adhesiveness-imparting agents, a silane coupling agent is preferably used within a range between 0.1 and 20 parts by weight, although it is not particularly limited.

To the curable composition in the fifth aspect of the present invention, a plasticizer, a filler, a physical property regulator, a thixotropic agent, an antioxidant, or the like, which are similar to those in the case of the curable composition in the first aspect of the present invention, can be added.

The polymer blend in the curable composition in the fifth aspect of the present invention is the similar to that in the curable composition in the first aspect of the present invention.

Storage Stability

With regard to compositions similar to the curable composition in the fifth aspect of the present invention, it is not preferable that the curing rate after a long-term storage is largely changed from that before the storage. For example, when the composition is used as a sealant, it is subjected to operations of adjusting the surface form after application to a joint or applying a finishing material or coating material. Thus, a change in the time when the surface is cured, that is, what is called skinning time, impairs such operations.

Storage conditions for confirming the effects of the present invention are not particularly limited. In general, a change in storage hardly occurs at a low temperature. The storage temperature becomes considerably high in summer. In order to quickly evaluate storage stability, the temperature is preferably set between a room temperature and 80° C. The evaluation was carried out at 50° C. in the examples of the present invention.

<<Sixth Invention>>

The sixth aspect of the present invention relates to a sealant, a liquid gasket, and an adhesive, for which the curable composition in the fifth aspect of the present invention is used.

The curable composition in the fifth aspect of the present invention has improved in terms of storage stability. Thus, it is preferably used for a sealant, a liquid gasket, and an adhesive.

More detailed uses regarding the aforementioned use of the curable composition in the fifth aspect of the present invention, and other uses, are the same as those described in the second aspect of the present invention.

<<Seventh Invention>>

The seventh aspect of the present invention relates to a curable composition comprising, as an essential component, the vinyl polymer (I) having at least one crosslinkable silyl group represented by the above described general formula (1), wherein the vinyl polymer (I) comprises a compound having a methyl ester group.

The crosslinkable silyl group represented by the general formula (1) is preferably located at the terminus of the vinyl polymer.

In the seventh aspect of the present invention, the vinyl polymer used as component (I) is preferably a (meth)acrylic polymer. In addition, the crosslinkable silyl group represented by the general formula (1) is preferably located at the terminus of the vinyl polymer.

A monomer containing a methyl ester group that constitutes the vinyl polymer used as component (I) is preferably methyl acrylate or methyl methacrylate, and more preferably methyl acrylate.

The vinyl polymer (I) is preferably in a liquid state at 23° C.

The vinyl polymer (I) is preferably synthesized by living radical polymerization, and more preferably synthesized by atom transfer radical polymerization.

The ratio of weight average molecular weight to number average molecular weight of vinyl polymer (I) is preferably less than 1.8. In this case, the ratio is determined by gel permeation chromatography.

The curable composition in the seventh aspect of the present invention is preferably a one-component curable composition.

The compound having a methyl ester group in the seventh aspect of the present invention may be either the vinyl polymer (I), or a compound other than the vinyl polymer (I). Examples of such a vinyl polymer (I) having a methyl ester group or a compound having a methyl ester group other than the component (I) may be the same as those described in the aforementioned first to sixth aspects of the present invention.

The curable composition in the seventh aspect of the present invention preferably comprises a condensation curing catalyst (III). In addition, a tin curing catalyst is preferable as such a condensation curing catalyst.

The curable composition in the seventh aspect of the present invention preferably comprises an amine compound (IV). In addition, an amino group contained in the amine compound is preferably a primary amine. Moreover, the amine compound is preferably a silane coupling agent.

In a preferred embodiment, the curable composition in the seventh aspect of the present invention comprises a polyether polymer having at least one crosslinkable silyl group represented by the general formula (1).

<<Eighth Invention>>

The eighth aspect of the present invention relates to a curable composition with improved storage stability, which comprises the following two components as essential components:

a vinyl polymer (I), which has at least one crosslinkable silyl group represented by the above described general formula (1) and does not comprise, as a constituent unit, a monomer having a methyl ester group; and

a compound (II) having a methyl ester group.

<<Ninth Invention>>

The ninth aspect of the present invention relates to a curable composition, which comprises the following two components as essential components:

a vinyl polymer (I), which has at least one crosslinkable silyl group represented by the above described general formula (1) and comprises, as a constituent unit, a monomer having a methyl ester group; and

a compound (II) having a methyl ester group other than the compound (I).

### EXAMPLES

The present invention will be further specifically described below in examples and comparative examples. However, these examples are not intended to limit the present invention.

In the examples and comparative examples given below, the terms “part” and “%” mean “part by weight” and “% by weight,” respectively.

In the examples given below, “number average molecular weight” and “molecular weight distribution (the ratio of the weight average molecular weight to the number average molecular weight)” were calculated as standard polystyrene-reduced values, using gel permeation chromatography (GPC). A column filled with crosslinked polystyrene gel (Shodex GPC K-804; manufactured by Showa Denko K.K.) was used as a GPC column, and chloroform was used as a GPC solvent.

### Example 1

### BA/MA Copolymer

3.67 g (25.6 mmol) of copper (I) bromide and 46 ml of acetonitrile were added to a 1-liter flask, and the mixture was stirred under heating in a nitrogen current at 70° C. for 20 minutes. Thereafter, 9.59 g (26.6 mmol) of diethyl 2,5-dibromoadipate, 425 ml (2.96 mol) of butyl arylate, and 41 ml (0.44 mol) of methyl acrylate were added to the reaction product, and the obtained mixture was further stirred under heating at 80° C. for 20 minutes. Thereafter, 0.444 ml (2.56 mmol) of pentamethyldiethylenetriamine (hereinafter referred to as triamine) was added to the reaction product, so as to initiate the reaction. Then, 0.178 ml (0.85 mmol) of triamine was further added thereto. The mixture was continuously stirred under heating at 80° C., and during the reaction, 0.178 ml (0.85 mmol) of triamine was added. 180 minutes after initiation of the reaction, the pressure in the reactor was reduced, so as to eliminate volatile substances. 240 minutes after initiation of the reaction, 140 ml of acetonitrile, 53 ml (0.43 mol) of 1,7-octadiene, and 1.78 ml (8.52 mmol) of triamine were added to the reaction product, and the thus obtained mixture was continuously stirred under heating at 80° C. 620 minutes after initiation of the reaction, the heating operation was terminated. The reaction solution was heated under a reduced pressure, so as to eliminate volatile substances, thereby obtaining a polymer. The obtained polymer, Kyoward 500 SH (Kyowa Chemical Co., Ltd.; 2 parts by weight with respect to 100 parts by weight of the polymer), and Kyoward 700 SL (Kyowa Chemical Co., Ltd.; 2 parts by weight with respect to 100 parts by weight of the polymer) were mixed with xylene (100 parts by weight with respect to 100 parts by weight of the polymer). The obtained mixture was stirred at 130° C. Three hours later, aluminum silicate was filtrated, and volatile substances were distilled away from the filtrate by heating under a reduced pressure. The polymer was heated under a reduced pressure at 180° C. for 12 hour, so as to distill away volatile substances. The obtained polymer, Kyoward 500 SH (Kyowa Chemical Co., Ltd.; 3 parts by weight with respect to 100 parts by weight of the polymer), and Kyoward 700 SL (Kyowa Chemical Co., Ltd.; 3 parts by weight with respect to 100 parts by weight of the polymer) were mixed with xylene (100 parts by weight with respect to 100 parts by weight of the polymer). The obtained mixture was stirred at 130° C. Five hours later, aluminum silicate was filtrated. Volatile substances were then distilled away from the filtrate by heating under a reduced pressure, so as to obtain a polymer [1] having an alkenyl group at the terminus.

The number average molecular weight of the polymer [1] was found to be 19,000, and the molecular weight distribution thereof was found to be 1.2. The average number of alkenyl groups per molecule that had been introduced into the polymer was obtained by ¹H-NMR analysis. As a result, it was found to be 2.0.

Subsequently, the above described polymer [1] (350.0 g), dimethoxymethylhydrosilane (13.25 ml, 107.4 mmol), dimethyl orthoformate (3.92 ml, 35.8 mmol), and a platinum catalyst were added to a 500-ml pressure-resistant glass reactor. The amount of the platinum catalyst used was set to 2×10⁻⁴ equivalence at a molar ratio with respect to alkenyl groups contained in the polymer [1]. The reaction mixture was heated at 100° C. for 30 minutes. Volatile substances were distilled away from the mixture under a reduced pressure, so as to obtain a polymer [2], poly(n-butyl acrylate/methyl acrylate) having silyl groups at the terminus. The number average molecular weight of the polymer [2] was found to be 20,000, and the molecular weight distribution thereof was found to be 1.2. The average number of silyl groups per molecule that had been introduced into the polymer was obtained by ¹H-NMR analysis. As a result, it was found to be 2.0.

### Example 2

### BA/MA/SA Copolymer

3.40 g (23.7 mmol) of copper (I) bromide and 47 ml of acetonitrile were added to a 1-liter flask, and the mixture was stirred under heating in a nitrogen current at 70° C. for 20 minutes. Thereafter, 7.80 g (21.7 mmol) of diethyl 2,5-dibromoadipate, 336 ml (2.34 mol) of butyl arylate, 59 ml (0.63 mol) of methylacrylate, and 77 ml (0.19 mol) of stearyl acrylate were added to the reaction product, and the obtained mixture was further stirred under heating at 80° C. for 20 minutes. Thereafter, 0.495 ml (2.37 mmol) of triamine was added to the reaction product, so as to initiate the reaction. Then, 0.165 ml (0.79 mmol) of triamine was further added thereto. The mixture was continuously stirred under heating at 80° C., and during the reaction, 0.165 ml (0.79 mmol) of triamine was added. 180 minutes after initiation of the reaction, the pressure in the reactor was reduced, so as to eliminate volatile substances. 240 minutes after initiation of the reaction, 141 ml of acetonitrile, 58 ml (0.40 mol) of 1,7-octadiene, and 1.65 ml (7.91 mmol) of triamine were added to the reaction product, and the thus obtained mixture was continuously stirred under heating at 80° C. 620 minutes after initiation of the reaction, the heating operation was terminated. The reaction solution was heated under a reduced pressure, so as to eliminate volatile substances, thereby obtaining a polymer. The obtained polymer, Kyoward 500 SH (Kyowa Chemical Co., Ltd.; 2 parts by weight with respect to 100 parts by weight of the polymer), and Kyoward 700 SL (Kyowa Chemical Co., Ltd.; 2 parts by weight with respect to 100 parts by weight of the polymer) were mixed with xylene (100 parts by weight with respect to 100 parts by weight of the polymer). The obtained mixture was stirred at 130° C. Three hours later, aluminum silicate was filtrated, and volatile substances were distilled away from the filtrate by heating under a reduced pressure. The polymer was heated under a reduced pressure at 180° C. for 12 hours, so as to distill away volatile substances. The obtained polymer, Kyoward 500 SH (Kyowa Chemical Co., Ltd.; 3 parts by weight with respect to 100 parts by weight of the polymer), and Kyoward 700 SL (Kyowa Chemical Co., Ltd.; 3 parts by weight with respect to 100 parts by weight of the polymer) were mixed with xylene (100 parts by weight with respect to 100 parts by weight of the polymer). The obtained mixture was stirred at 130° C. Five hours later, aluminum silicate was filtrated. Volatile substances were then removed from the filtrate by heating under a reduced pressure, so as to obtain a polymer [3] having an alkenyl group at the terminus.

The number average molecular weight of the polymer [3] was found to be 22,000, and the molecular weight distribution thereof was found to be 1.2. The average number of alkenyl groups per molecule that had been introduced into the polymer was obtained by ¹H-NMR analysis. As a result, it was found to be 2.1.

Subsequently, the above described polymer [3] (260.0 g), dimethoxymethylhydrosilane (8.46 ml, 68.6 mmol), dimethyl orthoformate (2.50 ml, 22.9 mmol), and a platinum catalyst were added to a 500-ml pressure-resistant glass reactor. The amount of the platinum catalyst used was set to 2×10⁻⁴ equivalence at a molar ratio with respect to alkenyl groups contained in the polymer [3]. The reaction mixture was heated at 100° C. for 30 minutes. Volatile substances were distilled away from the mixture under a reduced pressure, so as to obtain a polymer [4], poly(n-butyl acrylate/methyl acrylate/stearyl acrylate) having a silyl group at the terminus. The number average molecular weight of the polymer [4] was found to be 23,000, and the molecular weight distribution thereof was found to be 1.3, according to GPC measurement (calculation relative to polystyrene). The average number of silyl groups per molecule that had been introduced into the polymer was obtained by ¹H-NMR analysis. As a result, it was found to be 1.7.

### Comparative Example 1

### Butyl Acrylate Homopolymer

1.09 kg (7.61 mol) of copper (I) bromide and 11.4 kg of acetonitrile were added to a 250-liter pressure-resistant reactor, and the mixture was stirred under heating in a nitrogen current at 65° C. for 15 minutes. Thereafter, 2.28 kg (6.34 mol) of diethyl 2,5-dibromoadipate and 26.0 kg (203 mol) of butyl arylate were added to the reaction product, and the obtained mixture was further stirred under heating at 65° C. for 26 minutes. Thereafter, 22.0 g (0.127 mol) of triamine was added to the reaction product, so as to initiate the reaction. The mixture was continuously stirred under heating at 80° C. During the reaction, 109.8 g (0.634 mol) of triamine was further added, dividing into 3 times. From 30 minutes after initiation of the reaction, 104.0 kg (811 mol) of butyl acrylate was intermittently added dropwise thereto over 120 minutes. Moreover, during the reaction, 87.8 g (0.507 mol) of triamine was also added thereto. 314 minutes after initiation of the reaction, the pressure in the reactor was reduced, so as to eliminate volatile substances. 150 minutes after initiation of the pressure reduction, 34.3 kg of acetonitrile, 14.0 kg (187 mol) of 1,7-octadiene, and 439 g (2.53 mol) of triamine were added to the reaction product, and the thus obtained mixture was continuously stirred under heating at 80° C. Eight hours after addition of the octadiene, the pressure in the reactor was reduced, so as to eliminate volatile substances, thereby obtaining a polymer [5] having an alkenyl group at the terminus. The number average molecular weight of the polymer [5] was found to be 26,000, and the molecular weight distribution thereof was found to be 1.3. The average number of alkenyl groups per molecule that had been introduced into the polymer was obtained by ¹H-NMR analysis. As a result, it was found to be 2.1.

100 parts of methylcyclohexane was added to 100 parts of the polymer [5], and the mixture was heated at 100° C. for 3 hours. Insoluble portions were removed by filtration, and the remaining product was heated at 180° C. for 8 hours. Volatile substances were eliminated from the reaction product at 100° C. under a reduced pressure. Thereafter, 100 parts of methylcyclohexane, 2 parts of Kyoward 500 SH (manufactured by Kyowa Chemical Co., Ltd.), and 2 parts of Kyoward 700 SL (manufactured by Kyowa Chemical Co., Ltd.) were added thereto, and the obtained mixture was stirred at 150° C. for 4 hours. Solids were removed by filtration, and volatile substances were then eliminated at 130° C. under a reduced pressure.

Subsequently, a platinum catalyst, dimethoxymethylsilane, methyl orthoformate were added to the above described polymer. The amount of the platinum catalyst used was set at 10 ppm, and the amounts of the dimethoxymethylsilane and methyl orthoformate used were 2 moles equivalence and 1 mole equivalence, respectively, with respect to alkenyl groups contained in the polymer. The reaction mixture was heated at 100° C. for 30 minutes. Volatile substances were distilled from the mixture under a reduced pressure, so as to obtain a polymer [6], poly(n-butyl acrylate) having a silyl group at the terminus. The number average molecular weight of the polymer [6] was found to be 27,000, and the molecular weight distribution thereof was found to be 1.4. The average number of silyl groups per molecule that had been introduced into the polymer was obtained by ¹H-NMR analysis. As a result, it was found to be 1.7.

### Comparative Example 2

### Butyl Acrylate Homopolymer

Butyl acrylate was allowed to react with diethyl 2,5-dibromoadipate at a molar ratio of 128:1 in the same manner as described in Comparative example 1, so as to obtain a polymer [7], poly(n-butyl acrylate) having an alkenyl group at the terminus. Subsequently, a polymer [8], poly(n-butyl acrylate) having silyl groups at the terminus, was obtained in the same manner as in Comparative example 1. The number average molecular weight of the polymer [8] was found to be 21,000, and the molecular weight distribution thereof was found to be 1.3. The average number of silyl groups per molecule that had been introduced into the polymer was obtained by ¹H-NMR analysis. As a result, it was found to be 2.0.

### Example 3

50 parts of DIDP (diisodecyl phthalate; manufactured by Kyowa Hakko Co., Ltd.), 1.5 parts of vinyltrimethoxysilane, and 2 parts of N-(β-aminoethyl)-γ-aminopropyltrimethoxysilane were sufficiently mixed into 100 parts of the polymer [2] obtained in Example 1, using hands in a nitrogen atmosphere. Thereafter, 1 part of tetravalent Sn catalyst (dibutyltin diacetyl acetonate) was added thereto, so as to prepare a one-component composition.

### Example 4

A one-component composition was prepared in the same manner as described in Example 3 with the exception that the polymer [4] obtained in Example 2 was used instead of the polymer [2] obtained in Example 1.

### Comparative Example 3

A one-component composition was prepared in the same manner as described in Example 3 with the exception that the polymer [6] obtained in Comparative example 1 was used instead of the polymer [2] obtained in Example 1.

(Evaluation 1)

The one-component composition produced in each of Examples 3 and 4 and Comparative example 3 was stored at 50° C. for 4 weeks. Both the thus obtained composition and the composition obtained before the storage were cured at a room temperature. The skinning time was evaluated by comparison of the two compositions. It is to be noted that the skinning time in the present invention was evaluated as a period of time in which the composition mixed with a curing catalyst exhibited rubber elasticity and it was then detached from metal spatula.

The results are shown in Table 1.

TABLE 1

Skinning time (minute)

| | | Initial stage | After storage at |
|---|---|---|---|
| | Polymer | (before storage) | 50° C. for 4 weeks |
| Example 3 | [2] | 40 | 50 |
| Example 4 | [4] | 60 | 110 |
| Comparative | [6] | 40 | 230 |
| example 3 | | | |

In Comparative example 3, the curing time considerably delayed after the storage. In contrast, in Examples 3 and 4, such delay was suppressed.

### Example 5

1 part of tetravalent Sn catalyst (#918 dibutyltin diacetyl acetonate) was added to 100 parts of the polymer [2] obtained in Example 1. Both substances were sufficiently mixed, using hands, so as to prepare a sheet-like cured product with a thickness of approximately 2 mm. This cured product was left at rest at a room temperature for 2 days. Thereafter, it was left at 50° C. for 3 days for curing.

### Comparative Example 4

A sheet-like cured product was prepared in the same manner as described in Example 3 with the exception that the polymer [8] obtained in Comparative example 2 was used instead of the polymer [2] used in Example 3.

(Evaluation 2)

A 2(⅓) dumbbell specimen was stamped out of the cured product after curing. The tensile properties thereof were evaluated (using Autograph, manufactured by Shimazu Corp.; measurement temperature: 23° C.; and drawing rate: 200 mm/sec).

The results are shown in Table 2.

TABLE 2

Tensile physical properties

| | | Breaking | Breaking |
|---|---|---|---|
| | Polymer | strength (MPa) | elongation (%) |
| Example 5 | [2] | 0.46 | 150 |
| Comparative | [8] | 0.33 | 150 |
| example 4 | | | |

When compared with the cured product obtained in Comparative example 4, the cured product obtained in Example 5 had the same degree of elongation and higher strength.

### Example 6

A polyvalent hydrogen silicon compound and a 1,1,3,3-tetramethyl-1,3-divinyldisiloxane complex of zero-valent platinum (8.3×10⁻⁸ mol/L xylene solution) were fully mixed into the polymer [1] obtained in Example 1. As a polyvalent hydrogen silicon compound, methyl hydrogen siloxane (S-3; SiH value: 7.69 mmol/g), a portion of which had been modified by α-methylstyrene, was used. The amount of such a polyvalent hydrogen silicon compound used was set, such that the molar ratio of alkenyl groups in the polymer to SiH groups in the hydrogen silicon compound could be between 1:1.2 and 1:1.5. Moreover, the above platinum catalyst was added at a predetermined amount to alkenyl groups contained in the polymer used.

The thus obtained composition was deaerated under a reduced pressure, and it was then poured into a formwork, followed by heat curing. It was then heated to 180° C., so as to obtain a rubber-like cured product.

### Comparative Example 5

A sheet-like cured product was prepared in the same manner as described in Example 6 with the exception that the polymer [7] obtained in Comparative example 2 was used instead of the polymer [1] used in Example 6.

(Evaluation 3)

The mechanical properties of the cured products obtained in Example 6 and Comparative example 5 were measured in the same manner as described in Evaluation 2. The cured product in Example 6 had higher strength than that in Comparative example 5.

### Comparative Example 6

### Synthesis of Vinyl Polymer Having at Least One Crosslinkable Silyl Group at the Terminus

1.09 kg (7.61 mol) of copper (I) bromide and 11.4 kg of acetonitrile were added to a 250-liter pressure-resistance reactor, and the mixture was stirred under heating in a nitrogen current at 65° C. for 15 minutes. Thereafter, 2.28 kg (6.34 mol) of diethyl 2,5-dibromoadipate and 26.0 kg (203 mol) of butyl arylate were added to the reaction product, and the obtained mixture was further stirred under heating at 65° C. for 26 minutes. Thereafter, 22.0 g (0.127 mol) of pentamethyldiethylenetriamine (hereinafter referred to as triamine) was added to the reaction product, so as to initiate the reaction. Then, the mixture was continuously stirred under heating at 80° C. During the reaction, 109.8 g (0.634 mol) of triamine was added thereto, dividing into 3 times. From 30 minutes after initiation of the reaction, 104.0 kg (811 mol) of butyl acrylate was intermittently added dropwise thereto over 120 minutes. At the same period, 87.8 g (0.507 mol) of triamine was added thereto. 314 minutes after initiation of the reaction, the pressure in the reactor was reduced, so as to eliminate volatile substances. 150 minutes after initiation of the pressure reduction, 34.3 kg of acetonitrile, 14.0 kg (187 mol) of 1,7-octadiene, and 439 g (2.53 mol) of triamine were added to the reaction product, and the thus obtained mixture was continuously stirred under heating at 80° C. Eight hours after addition of the octadiene, the pressure in the reactor was reduced, so as to eliminate volatile substances, thereby obtaining a polymer [9] having an alkenyl group at the terminus. The number average molecular weight of the polymer [9] was found to be 26,000, and the molecular weight distribution thereof was found to be 1.3. The average number of alkenyl groups per molecule that had been introduced into the polymer was obtained by ¹H-NMR analysis. As a result, it was found to be 2.1.

100 parts of methylcyclohexane was added to 100 parts of the polymer [9], and the mixture was heated at 100° C. for 3 hours. Insoluble portions were removed by filtration, and the remaining product was heated at 180° C. for 8 hours. Volatile substances were eliminated from the reaction product at 100° C. under a reduced pressure. Thereafter, 100 parts of methylcyclohexane, 2 parts of Kyoward 500 SH (manufactured by Kyowa Chemical Co., Ltd.), and 2 parts of Kyoward 700 SL (manufactured by Kyowa Chemical Co., Ltd.) were added thereto, and the obtained mixture was stirred at 150° C. for 4 hours. Solids were removed by filtration, and volatile substances were then eliminated at 130° C. under a reduced pressure.

Subsequently, a platinum catalyst, dimethoxymethylsilane, methyl orthoformate were added to the above described polymer. The amount of the catalyst used was set at 10 ppm, and the amounts of the dimethoxymethylsilane and methyl orthoformate used were 2 moles equivalence and 1 mole equivalence, respectively, with respect to alkenyl groups contained in the polymer. The reaction mixture was stirred at 100° C. for 30 minutes. Volatile substances were distilled away from the mixture under a reduced pressure, so as to obtain a polymer [10], poly(n-butyl acrylate) having silyl groups at the terminus. The number average molecular weight of the polymer [10] was found to be 27,000, and the molecular weight distribution thereof was found to be 1.4. The average number of silyl groups per molecule that had been introduced into the polymer was obtained by ¹H-NMR analysis. As a result, it was found to be 1.7.

### Examples 7 to 12

The predetermined parts of various types of methyl ester compounds (refer to Table 3), 1.5 parts of vinyltrimethoxysilane, and 2 parts of N-(β-aminoethyl)-γ-aminopropyltrimethoxysilane were sufficiently mixed into 100 parts of the polymer [10] obtained in Comparative example 6, using hands in a nitrogen atmosphere. Thereafter, 1 part of tetravalent Sn catalyst (dibutyltin diacetyl acetonate) was added thereto, so as to prepare a one-component composition.

### Comparative Example 7

A one-component composition was prepared in the same manner as described in Example 7 with the exception that 50 parts of DIDP (diisodecyl phthalate; manufactured by Kyowa Hakko Co., Ltd.) was used instead of the methyl ester compound used in Example 7.

(Evaluation 4)

The one-component composition produced in each of Examples 7 to 12 and Comparative example 7 was stored at 50° C. for 2 weeks or 4 weeks. The compositions obtained after the storage for 2 weeks or 4 weeks, and the composition obtained before the storage, were cured at a room temperature. The skinning time was evaluated by comparison of these compositions. It is to be noted that the skinning time in the present invention was evaluated as a period of time in which the composition mixed with a curing catalyst exhibited rubber elasticity and it was then detached from metal spatula.

The results are shown in Table 3.

TABLE 3

| | | | Skinning time (minute) | | |
|---|---|---|---|---|---|
| | | Number | Before | | |
| | | of parts | storage | After storage | |
| | Methyl ester | added | Initial | (50° C.) | |
| | compound | (part) | stage | 2 weeks | 4 weeks |
| Example 7 | Methyl adipate | 50 | 40 | 40 | 40 |
| Example 8 | Methyl adipate | 10 | 30 | 30 | |
| Example 9 | Methyl adipate | 5 | 30 | 40 | |
| Example 10 | Methyl oleate | 10 | 30 | 60 | |
| Example 11 | Methyl stearate | 10 | 30 | 60 | |
| Example 12 | Methyl sebacate | 10 | 30 | 40 | |
| Comparative | DIDP | 50 | 40 | 100 | 230 |
| example 7 | | | | | |

In the case of Comparative example 7, as the storage period lengthened, the curing time (skinning time) also lengthened. In contrast, in Examples 7 to 12, delay in curing was suppressed. In addition, it is likely that the greater the number of moles of the methyl ester group added, the larger the effect of suppressing delay in curing that can be obtained.

### Comparative Example 8

Synthesis of Poly(n-Butyl Acrylate) Having Crosslinkable Silyl Group at the Terminus

8.39 g (58.5 mmol) of copper (I) bromide and 112 ml of acetonitrile were added to a 2-liter flask, and the mixture was stirred under heating in a nitrogen current at 70° C. for 30 minutes. Thereafter, 17.6 g (48.8 mmol) of diethyl 2,5-dibromoadipate and 224 ml (1.56 mol) of butyl arylate were added to the reaction product, and the obtained mixture was further stirred under heating at 70° C. for 45 minutes. Thereafter, 0.41 ml (1.95 mmol) of pentamethyldiethylenetriamine (hereinafter referred to as triamine) was added to the reaction product, so as to initiate the reaction. The mixture was continuously stirred under heating at 70° C. From 80 minutes after initiation of the reaction, 895 ml (6.24 mol) of butyl acrylate was intermittently added dropwise thereto over 160 minutes. At the same period, 1.84 ml (8.81 mmol) of triamine was added thereto. 375 minutes after initiation of the reaction, 288 ml (1.95 mol) of 1,7-octadiene and 4.1 ml (19.5 mmol) of triamine were added thereto, and the mixture was continuously stirred under heating at 70° C. Thereafter, 615 minutes after initiation of the reaction, the heating operation was terminated. The reaction solution was diluted with toluene, and the dilute was then filtrated. The filtrate was heated under a reduced pressure, so as to obtain a polymer [11]. The number average molecular weight of the obtained polymer [11] was found to be 24,100, and the molecular weight distribution thereof was found to be 1.27, according to GPC measurement (mobile phase: chloroform; calculation relative to polystyrene). The average number of alkenyl groups per molecule that had been introduced into the polymer was obtained by ¹H-NMR analysis. As a result, it was found to be 2.6.

The obtained polymer, 11.9 g (0.121 mol) of potassium acetate, and 900 ml of DMAc were added to a 2-liter flask in a nitrogen atmosphere, and the obtained mixture was stirred under heating at 100° C. for 11 hours. Thereafter, the reaction solution was heated under a reduced pressure, so as to eliminate DMAc. Thereafter, toluene was added thereto, and the mixture was filtrated. An adsorbent (200 g; manufactured by Kyowa Chemical Co., Ltd.; Kyoward 700 PEL) was added to the filtrate, and the obtained mixture was then stirred under heating at 100° C. for 3 hours in a nitrogen current. Thereafter, the adsorbent was eliminated by filtration, and toluene was then distilled away from the filtrate under a reduced pressure, so as to obtain a polymer [12].

The polymer [12] (648 g), dimethoxymethylhydrosilane (25.5 ml, 0.207 mol), methyl orthoformate (7.54 ml, 0.0689 mol), and 1,1,3,3-tetramethyl-1,3-divinyldisiloxane complex of zero-valent platinum, were added to a 1-liter pressure-resistant reactor. The amount of the platinum catalyst used was set to 3×10⁻³ equivalence at a molar ratio with respect to alkenyl groups contained in the polymer. The reaction mixture was stirred under heating at 100° C. for 2 hours. Volatile substances were distilled away from the mixture under a reduced pressure, so as to obtain a polymer having silyl groups at the terminus (polymer [13]). The number average molecular weight of the obtained polymer was found to be 29, 600, and the molecular weight distribution thereof was found to be 1.9, according to GPC measurement (calculation relative to polystyrene). The average number of silyl groups per molecule that had been introduced into the polymer was obtained by ¹H-NMR analysis. As a result, it was found to be 1.9.

### Example 13

Synthesis of Poly(n-Butyl Acrylate/Methyl Acrylate) Copolymer Having Crosslinkable Silyl Group

A vinyl copolymer [14] having an alkenyl group at the terminus was obtained in the same manner as described in Comparative example 8 with the exception of the use of 3.67 g (25.6 mmol) of CuBr, 46 ml of acetonitrile, 9.59 g (26.6 mmol) of diethyl 2,5-dibromoadipate, 425 ml (2.96 mol) of butyl acrylate, 41 ml (0.44 mol) of methyl acrylate, 2.58 ml (12.78 mmol) of triamine, 140 ml of acetonitrile, and 53 ml (0.43 mol) of 1,7-octadiene.

This copolymer [14] (350 g) was used with dimethoxymethylhydrosilane (13.25 ml, 107.4 mmol), dimethyl orthoformate (3.92 ml, 35.8 mmol), and a platinum catalyst, so as to obtain a poly(n-butyl acrylate/methyl acrylate) copolymer [15] having silyl groups at the terminus. The number average molecular weight of the obtained copolymer was found to be approximately 20,000, and the molecular weight distribution thereof was found to be 1.2. The average number of silyl groups per molecule that had been introduced into the copolymer was obtained by ¹H-NMR analysis. As a result, it was found to be approximately 2.0.

### Example 14

Synthesis of Poly(n-Butyl Acrylate/Methyl Acrylate/Stearyl Acrylate) Copolymer Having Crosslinkable Silyl Group

A vinyl copolymer [16] having an alkenyl group at the terminus was obtained in the same manner as described in Comparative example 8 with the exception of the use of 3.40 g (23.7 mmol) of CuBr, 47 ml of acetonitrile, 7.80 g (21.7 mmol) of diethyl 2,5-dibromoadipate, 336 ml (2.34 mol) of butyl acrylate, 59 ml (0.63 mol) of methyl acrylate, 77 ml (0.19 mol) of stearyl acrylate, 2.475 ml (11.86 mmol) of triamine, 141 ml of acetonitrile, and 58 ml (0.40 mol) of 1,7-octadiene.

This copolymer [16] (260 g) was used with dimethoxymethylhydrosilane (8.46 ml, 68.6 mmol), dimethyl orthoformate (2.50 ml, 22.9 mmol), and a platinum catalyst, so as to obtain a poly(n-butyl acrylate/methyl acrylate) copolymer [17] having silyl groups at the terminus. The number average molecular weight of the obtained copolymer was found to be approximately 23,000, and the molecular weight distribution thereof was found to be 1.3. The average number of silyl groups per molecule that had been introduced into the copolymer was obtained by ¹H-NMR analysis. As a result, it was found to be approximately 1.7.

### Synthetic Example 1

Synthesis of Acrylic Plasticizer (n-Butyl Acrylate/Methyl Acrylate Copolymer)

A solution, in which 22.4 g (0.26 mol) of methylacrylate, 77.6 g (0.61 mol) of butylacrylate, 10 g (0.05 mol) of n-dodecyl mercaptan, 2.7 g of 2,2′-azobis (2-methylbutyronitrile), and 20 g of toluene had been dissolved, was added dropwise to 50 g of toluene that had been heated to 105° C., over 5 hours. Thereafter, a solution obtained by dissolving 0.3 g of 2,2′-azobis(2-methylbutyronitrile) in 10 g of toluene was added dropwise to the reaction solution over 1 hour. Thereafter, the “post polymerization” was carried out for 2 hours, so as to obtain a vinyl copolymer [18].

Toluene was removed from the obtained solution by reduced-pressure distillation using an evaporator, so as to obtain an acrylic copolymer. The number average molecular weight of the obtained copolymer was found to be 2,174, the molecular weight distribution thereof was found to be 2.7, and the viscosity thereof was found to be ______.

### Example 15

With respect to 100 parts by weight of the polymer [13] obtained in Comparative example 8, 60 parts by weight of DIDP (diisodecyl phthalate) acting as a plasticizer, 150 parts by weight of colloidal calcium carbonate (manufactured by Shiraishi Kogyo Kaisha, Ltd.; product name: CCR), 20 parts by weight of heavy calcium carbonate (manufactured by Maruo Calcium Co., Ltd.; product name: Nanox 25A), 10 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 213), and 1 part by weight of hinderd amine light stabilizer (manufactured by Sankyo Co., Ltd.; product name: Sanol LS765) were measured. These substances were blended and fully mixed, and the obtained mixture was then passed through a small triple paint roll 3 times. Thereafter, reduced-pressure dehydration was carried out at 120° C. for 2 hours, and the resultant product was cooled to 50° C. or lower. Thereafter, 5 parts by weight of carbon dimethyl ester (manufactured by Daihachi Chemical Industry, Co., Ltd.; product name: DMA (dimethyl adipate)), 2 parts by weight of vinyltrimethoxysilane, 2 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Example 16

A test was carried out by the same method as applied in Example 15 with the exception that 10 parts by weight of DMA (dimethyl adipate) was added.

### Example 17

A test was carried out by the same method as applied in Example 15 with the exception that 10 parts by weight of DMSe (dimethyl sebacate) was added instead of DMA (dimethyl adipate).

### Example 18

A test was carried out by the same method as applied in Example 15 with the exceptions that 80 parts by weight of Arufon UP 1020 (manufactured by Toagosei, Co., Ltd.) was used as a plasticizer instead of DIDP, and that 20 parts by weight of DMA was added.

### Example 19

With respect to 100 parts by weight of the copolymer [15] obtained in Example 13, 80 parts by weight of DIDP (diisodecyl phthalate) acting as a plasticizer, 150 parts by weight of colloidal calcium carbonate (manufactured by Shiraishi Kogyo Kaisha, Ltd.; product name: CCR), 20 parts by weight of heavy calcium carbonate (manufactured by Maruo Calcium Co., Ltd.; product name: Nanox 25A), 10 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 213), and 1 part by weight of hinderd amine light stabilizer (manufactured by Sankyo Co., Ltd.; product name: Sanol LS765) were measured. These substances were blended and fully mixed, and the obtained mixture was then passed through a small triple paint roll 3 times. Thereafter, reduced-pressure dehydration was carried out at 120° C. for 2 hours, and the resultant product was cooled to 50° C. or lower. Thereafter, 2 parts by weight of vinyltrimethoxysilane, 2 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Example 20

With respect to 100 parts by weight of the copolymer [17] obtained in Example 14, 80 parts by weight of PPG (manufactured by Bayer; ACCLAIM12200) having a number average molecular weight of 12,000 that acts as a plasticizer, 150 parts by weight of colloidal calcium carbonate (manufactured by Shiraishi Kogyo Kaisha, Ltd.; product name: CCR), 20 parts by weight of heavy calcium carbonate (manufactured by Maruo Calcium Co., Ltd.; product name: Nanox 25A), 10 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 213), and 1 part by weight of hinderd amine light stabilizer (manufactured by Sankyo Co., Ltd.; product name: Sanol LS765) were measured. These substances were blended and fully mixed, and the obtained mixture was then passed through a small triple paint roll 3 times. Thereafter, reduced-pressure dehydration was carried out at 120° C. for 2 hours, and the resultant product was cooled to 50° C. or lower. Thereafter, 2 parts by weight of vinyltrimethoxysilane, 2 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Example 21

With respect to 100 parts by weight of the polymer [13] obtained in Comparative example 8, 80 parts by weight of the polymer obtained in Synthetic example 1 acting as a plasticizer, 150 parts by weight of colloidal calcium carbonate (manufactured by Shiraishi Kogyo Kaisha, Ltd.; product name: CCR), 20 parts by weight of heavy calcium carbonate (manufactured by Maruo Calcium Co., Ltd.; product name: Nanox 25A), 10 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 213), and 1 part by weight of hinderd amine light stabilizer (manufactured by Sankyo Co., Ltd.; product name: Sanol LS765) were measured. These substances were blended and fully mixed, and the obtained mixture was then passed through a small triple paint roll 3 times. Thereafter, reduced-pressure dehydration was carried out at 120° C. for 2 hours, and the resultant product was cooled to 50° C. or lower. Thereafter, 2 parts by weight of vinyltrimethoxysilane, 2 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Synthetic Example 2

A solution, in which 14.5 g (0.14 mol) of methyl methacrylate, 68.5 g (0.53 mol) of butyl acrylate, 15 g (0.08 mol) of stearyl methacrylate, 2 g (8.6 mmol) of γ-methacryloxypropylmethyldimethoxysilane, 0.5 g of 2,2′-azobis(2-methylbutyronitrile), and 20 g of toluene had been dissolved, was added dropwise to 50 g of toluene that had been heated to 105° C., over 5 hours. Thereafter, the “post polymerization” was carried out for 1 hour, so as to obtain a vinyl copolymer [19].

### Comparative Example 9

500 g of linear polypropylene oxide with a number average molecular weight of 20,000, the main chain skeleton of which was obtained using a composite metal cyanide complex catalyst and the terminus of which was an allyl group, and 10 g of hexane, were added to a pressure-resistant glass reactor equipped with a stirrer, followed by azeotropic dehydration at 90° C. Hexane was removed by reduced-pressure distillation, and then nitrogen substitution was carried out. Thereafter, 20 μl of chloroplatinic acid catalyst (5% by weight of isopropanol solution calculated relative to platinum) was added to the resultant product, and 4.6 g of DMS (dimethoxymethylsilane) was slowly added dropwise thereto, while stirring. The mixed solution was reacted at 90° C. for 2 hours, and unreacted DMS was then removed by reduced-pressure distillation, so as to obtain a silylated polymer. This polymer was blended with the copolymer [13] obtained in Comparative example 8 at a weight ratio of solids of 70:30. Thereafter, the solvent was removed by distillation, so as to obtain a non-solvent polymer [20]. When the blended ratio was set at 75:25, the viscosity of the polymer was 49.8 Pa/s. When the blended ratio was set at 70:30, it was 60.7 Pa/s, and when the blended ratio was set at 65:35, it was 86.2 Pa/s, wherein a BM type viscometer, rotor No. 4 was used at 23° C.

### Comparative Example 10

Propylene oxide was polymerized using a composite metal cyanide complex catalyst (zinc hexacyanocobaltate), so as to obtain an oxypropylene polymer. The obtained oxypropylene polymer was treated by the method described in Synthetic example 1 of Japanese Patent Laid-Open No. 5-117521, so as to synthesize an oxypropylene polymer [21] having a reactive silicon group at the terminus, which had a number average molecular weight of 11,000 and Mw/Mn of 1.9. The ratio of introduction of reactive silicon groups into all the termini was 65%.

The polymer [21] was blended with the copolymer [13] obtained in Comparative example 8 at a weight ratio of solids of 70:30. Thereafter, the solvent was removed by distillation, so as to obtain a polymer [22].

### Example 22

With respect to 100 parts by weight of the polymer [20] obtained in Comparative example 9, 55 parts by weight of PPG (polypropylene glycol) with a number average molecular weight of 3,000 used as a plasticizer, 120 parts by weight of calcium carbonate (manufactured by Shiraishi Kogyo Kaisha, Ltd.; product name: CCR), 20 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 327), and 1 part by weight of hinderd amine light stabilizer (manufactured by Sankyo Co., Ltd.; product name: Sanol LS770) were measured. These substances were blended and fully mixed, and the obtained mixture was then passed through a small triple paint roll 3 times. Thereafter, 10 parts by weight of dimethyl adipate (DMA), 2 parts by weight of vinyltrimethoxysilane, 3 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Example 23

A composition was produced and evaluated by the same method as applied in Example 22 with the exceptions that the polymer in Comparative example 10 was used instead of the polymer in Comparative example 9, and that DIDP was used as a plasticizer instead of PPG with a molecular weight of 3,000.

### Comparative Example 11

A test was carried out by the same method as applied in Example 15 with the exception that DMA was not added.

### Comparative Example 12

A test was carried out by the same method as applied in Example 22 with the exception that DMA was not added.

### Comparative Example 13

A test was carried out by the same method as applied in Example 23 with the exception that DMA was not added.

The results of Examples 15 to 23 and Comparative examples 11 to 13 are shown in Tables 4, 5, and 6.

In the tables, items to be measured indicate the following meanings.

Surface Curing Time

Initial stage: measured 7 days after production of one-component

After storage: measured after the storage under conditions of 50° C.×4 weeks

Curing Delay Magnification

Surface curing time after the storage/surface curing time at the initial stage

Residual Tackiness

M: tackiness is felt when touched with fingers

G: almost no tackiness is felt

E: no tackiness is felt

TABLE 4

| | | | | Exam- | Exam- | Exam- |
|---|---|---|---|---|---|---|
| | | Example | Example | ple | ple | ple |
| Items to be tested | | 15 | 16 | 17 | 18 | 19 |
| Surface | Initial | 55 | 55 | 50 | 120 | 55 |
| curing | stage | | | | | |
| time | After | 105 | 50 | 110 | 120 | 105 |
| (minute) | storage | | | | | |
| Curing delay | | 1.91 | 0.91 | 2.20 | 1.00 | 1.91 |
| magnification | | | | | | |
| Residual | 3^{rd} day | M to G | G | M to G | M | M |
| tackiness | 7^{th} day | G to E | E | G to E | G | G |

| | | | | | |
|---|---|---|---|---|---|
| M100 (MPa) | 0.41 | 0.42 | 0.35 | 0.31 | 0.53 |
| TB (MPa) | 0.91 | 0.95 | 0.83 | 0.74 | 1.00 |
| Eb (%) | 383 | 359 | 378 | 390 | 304 |

TABLE 5

| | | | | Exam- | Exam- |
|---|---|---|---|---|---|
| Items to be tested | | Example 20 | Example 21 | ple 22 | ple 23 |
| Surface | Initial | 65 | 80 | 40 | 70 |
| curing | stage | | | | |
| time | After | 80 | 160 | 40 | 60 |
| (minute) | storage | | | | |
| Curing delay | | 1.23 | 2.00 | 1.00 | 0.86 |
| magnification | | | | | |
| Residual | 3^{rd} day | M | M | G to E | G to E |
| tackiness | 7^{th} day | G | G | E | E |

| | | | | |
|---|---|---|---|---|
| M100 (MPa) | 0.37 | 0.30 | 0.22 | 0.29 |
| TB (MPa) | 1.05 | 0.79 | 1.21 | 1.03 |
| Eb (%) | 380 | 370 | 786 | 700 |

TABLE 6

| | | Comparative | Comparative | Comparative |
|---|---|---|---|---|
| Items to be tested | | example 11 | example 12 | example 13 |
| Surface curing | Initial | 60 | 45 | 70 |
| time (minute) | stage | | | |
| | After | 360 | 90 | 154 |
| | storage | | | |
| Curing delay | | 6.00 | 2.00 | 2.20 |
| magnification | | | | |
| Residual | 3^{rd} day | M | G to E | G to E |
| tackiness | 7^{th} day | G | G to E | G to E |

| | | | |
|---|---|---|---|
| M100 (MPa) | 0.31 | 0.27 | 0.25 |
| TB (MPa) | 0.77 | 1.20 | 1.00 |
| Eb (%) | 410 | 748 | 710 |

### Synthetic Example 3

A solution, in which 14.5 g of methyl methacrylate, 68.5 g of butyl acrylate, 15 g of stearyl methacrylate, 2 g of γ-methacryloxypropylmethyldimethoxysilane, 0.5 g of 2,2′-azobis(2-methylbutyronitrile), and 20 g of toluene had been dissolved, was added dropwise to 50 g of toluene that had been heated to 105° C., over 5 hours. Thereafter, the “post polymerization” was carried out for 1 hour, so as to obtain a vinyl copolymer.

### Synthetic Example 4

500 g of linear polypropylene oxide with a number average molecular weight of 20,000, the main chain skeleton of which was obtained using a composite metal cyanide complex catalyst and the terminus of which was an allyl group, and 10 g of hexane, were added to a pressure-resistant glass reactor equipped with a stirrer, followed by azeotropic dehydration at 90° C. Hexane was removed by reduced-pressure distillation, and then nitrogen substitution was carried out. Thereafter, 20 μl of chloroplatinic acid catalyst (5% by weight of isopropanol solution calculated relative to platinum) was added to the resultant product, and 4.6 g of DMS (dimethoxymethylsilane) was slowly added dropwise thereto, while stirring. The mixed solution was reacted at 90° C. for 2 hours, and unreacted DMS was then removed by reduced-pressure distillation, so as to obtain a silylated polymer. This polymer was blended with the copolymer obtained in Synthetic example 3 at a weight ratio of solids of 70:30. Thereafter, the solvent was removed by distillation, so as to obtain a non-solvent polymer (A). When the blended ratio was set at 75:25, the viscosity of the polymer was 49.8 Pa/s. When the blended ratio was set at 70:30, it was 60.7 Pa/s, and when the blended ratio was set at 65:35, it was 86.2 Pa/s, wherein a BM type viscometer, rotor No. 4 was used at 23° C.

### Example 24

With respect to 100 parts by weight of the polymer obtained in Synthetic example 4, 55 parts by weight of PPG (polypropylene glycol) with a number average molecular weight of 3,000 used as a plasticizer, 120 parts by weight of calcium carbonate (manufactured by Shiraishi Kogyo Kaisha, Ltd.; product name: CCR) 20 parts by weight of titanium oxide (manufactured by Ishihara Sangyo Kaisha, Ltd.; product name: R-820), 2 parts by weight of thixotropic agent (manufactured by Kusumoto Chemicals, Ltd.; product name: D-6500), 1 part by weight of benzotriazole ultraviolet absorber (manufactured by Ciba Special Chemicals, product name: Tinuvin 327), and 1 part by weight of hinderd amine light stabilizer (manufactured by Sankyo Co., Ltd.; product name: Sanol LS770) were measured. These substances were blended and fully mixed, and the obtained mixture was then passed through a small triple paint roll 3 times. Thereafter, 10 parts by weight of dimethyl adipate, 2 parts by weight of vinyltrimethoxysilane, 3 parts by weight of aminosilane compound (manufactured by Nippon Unicar Co., Ltd.; product name: A-1120), and 2 parts by weight of curing promoter (Nitto Kasei Co., Ltd.; product name: U-220) were added thereto and mixed, so as to obtain a curable composition. The surface curing time of the above curable composition was measured under conditions of 23° C.×55% R.H. In addition, a sheet-like curable sample with a thickness of 3 mm was produced from the above curable composition in accordance with JIS A5758. Thus, dumbbell (JIS A) used for a tensile test was produced.

### Example 25

A test was carried out by the same method as applied in Example 24 with the exception that 10 parts by weight of dimethyl sebacate was added instead of dimethyl adipate.

### Comparative Example 14

A test was carried out by the same method as applied in Example 24 with the exception that dimethyl adipate was not added.

The tensile properties of tensile test dumbbells produced in Examples 24 and 25 and Comparative example 14 were measured using Autograph (manufactured by Shimadzu Corp.; AG500C). The results are shown in Table 7. In the table, M100 indicates the modulus obtained by 100% elongation, Tb indicates breaking strength, and Eb indicates breaking elongation.

The items to be measured other than those regarding the tensile test indicate the following meanings.

Surface Curing Time

Initial stage: measured 7 days after production of one-component

After storage: measured after the storage under conditions of 50° C.×4 weeks

Curing Delay Magnification

Surface curing time after the storage/surface curing time at the initial stage

Residual Tackiness

M: tackiness is felt when touched with fingers

G: almost no tackiness is felt

E: no tackiness is felt

TABLE 7

| | | | | Comparative |
|---|---|---|---|---|
| Items to be tested | | Example 24 | Example 25 | example 14 |
| Surface curing | Initial | 40 | 40 | 45 |
| time (minute) | stage | | | |
| | After | 40 | 40 | 90 |
| | storage | | | |
| Curing delay | | 1.00 | 1.00 | 2.00 |
| magnification | | | | |
| Residual | 3^{rd} day | G to E | G to E | G to E |
| tackiness | 7^{th} day | E | E | G to E |

| | | | |
|---|---|---|---|
| M100 (MPa) | 0.23 | 0.22 | 2.7 |
| TB (MPa) | 1.23 | 1.21 | 1.20 |
| Eb (%) | 813 | 786 | 748 |

### INDUSTRIAL APPLICABILITY

According to the first, second, third, fourth, and seventh aspects of the present invention, a curable composition having improved storage stability is obtained due to methyl ester groups contained in a polymer. In addition, utilizing the improved storage stability, this curable composition can preferably be used for a sealant or the like. The use of a polymer having a methyl ester group at an appropriate composition ratio enables the improvement of the mechanical properties of a cured product obtained.

Moreover, according to the fifth, sixth, and seventh aspects of the present invention, a curable composition having improved storage stability, which comprises a vinyl polymer having a crosslinkable silyl group as an essential component, is obtained by adding a compound having a methyl ester group.

1. A curable composition comprising, as an essential component, (I) a vinyl polymer, which has at least one crosslinkable silyl group at the terminus and a monomer containing a methyl ester group as an essential constituent unit, the crosslinkable silyl group represented by general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

2. The curable composition according to claim 1, wherein the vinyl polymer (I) is a (meth)acrylic polymer.

3. The curable composition according to claim 1, wherein the monomer containing a methyl ester group which constitutes the vinyl polymer (I) is methyl acrylate.

4. The curable composition according to claim 1, wherein the monomer containing a methyl ester group which constitutes the vinyl polymer (I) is methyl methacrylate.

5. The curable composition according to claim 1, wherein the vinyl polymer (I) is in a liquid state at 23° C.

6. The curable composition according to claim 1, wherein the vinyl polymer (I) is synthesized by living radical polymerization.

7. The curable composition according to claim 1, wherein the vinyl polymer (I) is synthesized by atom transfer radical polymerization.

8. The curable composition according to claim 1, wherein the vinyl polymer (I) has a ratio of weight average molecular weight to number average molecular weight of less than 1.8, the ratio being determined by gel permeation chromatography.

9. The curable composition according to claim 1, wherein the curable composition is a one-component curable composition.

10. The curable composition according to claim 1, which comprises a condensation curing catalyst (II) as an essential component.

11. The curable composition according to claim 10, wherein the condensation curing catalyst (II) is a tin curing catalyst.

12. The curable composition according to claim 1, which comprises an amine compound (III) as an essential component.

13. The curable composition according to claim 12, wherein the amino group contained in the amine compound (III) is a primary amine.

14. The curable composition according to claim 12, wherein the amine compound is a silane coupling agent.

15. The curable composition according to claim 1, comprising a polyether polymer having at least one crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

16. A sealant, wherein the curable composition according to claim 1 is used.

17. A liquid gasket, wherein the curable composition according to claim 1 is used.

18. An adhesive, wherein the curable composition according to claim 1 is used.

19. A polymer, wherein the polymer has at least one crosslinkable functional group at the terminus and also has a vinyl polymer as a main chain thereof, wherein 2% to 80% by weight of monomers based on the total monomers constituting the main chain is methyl acrylate.

20. The polymer according to claim 19, wherein 5% to 50% by weight of monomers based on the total monomers constituting the main chain is methyl acrylate.

21. The polymer according to claim 20, wherein 5% to 20% by weight of monomers based on the total monomers constituting the main chain is methyl acrylate.

22. A polymer comprising at least one crosslinkable functional group at the terminus and also has a vinyl polymer as a main chain thereof, wherein 2% to 50% by weight of monomers based on the total monomers constituting the main chain is methyl methacrylate.

23. The polymer according to claim 22, wherein 2% to 20% by weight of monomers based on the total monomers constituting the main chain is methyl methacrylate.

24. The polymer according to claim 19, wherein the vinyl polymer as a main chain is a (meth)acrylic polymer.

25. The polymer according to claim 19, wherein the main chain is synthesized by living radical polymerization.

26. The polymer according to claim 19, wherein the main chain is synthesized by atom transfer radical polymerization.

27. The vinyl polymer according to claim 19, wherein the crosslinkable functional group is a crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

28. The vinyl polymer according to claim 19, wherein the crosslinkable functional group is an alkenyl group.

29. The vinyl polymer according to claim 19, wherein the crosslinkable functional group is a (meth)acryloyl group.

30. The vinyl polymer according to claim 19, wherein the crosslinkable functional group is a hydroxyl group.

31. A curable composition comprising the polymer according to claim 19 as an essential component.

32. A curable composition with improved storage stability, which comprises the following two components as essential components:
(I) a vinyl polymer having at least one crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1; and
a compound (II) having a methyl ester group other than the compound (I).

33. The curable composition according to claim 32, wherein the vinyl polymer is an acrylic polymer.

34. The curable composition according to claim 33, wherein the vinyl polymer is an acrylic ester polymer.

35. The curable composition according to claim 32, wherein the vinyl polymer (I) is synthesized by living radical polymerization.

36. The curable composition according to claim 32, wherein the vinyl polymer (I) is synthesized by atom transfer radical polymerization.

37. The curable composition according to claim 32, wherein the vinyl polymer (I) has a ratio of weight average molecular weight to number average molecular weight of less than 1.8, the ratio being determined by gel permeation chromatography.

38. The curable composition according to claim 32, wherein the curable composition is a one-component curable composition.

39. The curable composition according to claim 32, wherein the compound (II) having a methyl ester group other than the compound (I) is not a polymer.

40. The curable composition according to claim 32, wherein the carbon atom at the α-position of the methyl ester group contained in the compound (II) having a methyl group other than the compound (I) is primary or secondary.

41. The curable composition according to claim 32, wherein the compound (II) having a methyl ester group other than the compound (I) is selected from the group consisting of:
dimethyl malonate, dimethyl succinate, dimethyl glutarate, dimethyl adipate, dimethyl sebacate, methyl acetate, methyl propionate, methyl butyrate, methyl valerate, methyl caprylate, methyl caprate, methyl laurate, methyl myristate, methyl palmitate, methyl stearate, methyl oleate, methyl ricinoleate, and coconut fatty acid methyl ester.

42. The curable composition according to claim 32, wherein the compound (II) having a methyl ester group other than the compound (I) is a polymer containing a monomer having a methyl ester group as a constituent unit.

43. The curable composition according to claim 42, wherein the monomer having a methyl ester group is methyl acrylate.

44. The curable composition according to claim 42, wherein the compound having a methyl ester group is a copolymer containing a monomer having a methyl ester group as a constituent, and that among ester groups contained in monomers other than the monomer having a methyl ester group, those having an alkoxy group that is primary and contains 5 or more carbon atoms make up 80% or less at a molar ratio with respect to the methyl ester groups.

45. The curable composition according to claim 42, wherein the compound having a methyl ester group is a copolymer containing a monomer having a methyl ester group as a constituent, and that among ester groups contained in monomers other than the monomer having a methyl ester group, those having an alkoxy group that is primary and contains 2 to 4 carbon atoms make up 400% or less at a molar ratio with respect to the methyl ester groups.

46. The curable composition according to claim 32, wherein the curable composition comprises a condensation curing catalyst (III) as an essential component.

47. The curable composition according to claim 46, wherein the condensation curing catalyst (III) is a tin curing catalyst.

48. The curable composition according to claim 42, comprising an amine compound (IV) as an essential component.

49. The curable composition according to claim 48, wherein an amino group contained in the amine compound (IV) is a primary amine.

50. The curable composition according to claim 48, wherein the amine compound is a silane coupling agent.

51. The curable composition according to claim 32, comprising a polyether polymer having at least one crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.

52. The curable composition according to claim 32, wherein the compound (II) having a methyl ester group other than the compound (I) is a dimethyl ester of dicarboxylic acid.

53. A sealant, wherein the curable composition according to claim 32 is used.

54. A liquid gasket, wherein the curable composition according to claim 32 is used.

55. An adhesive, wherein the curable composition according to claim 32 is used.

56. A curable composition comprising, as an essential component, (I) a vinyl polymer having at least one crosslinkable silyl group, comprising a compound having a methyl ester group, the crosslinkable silyl group represented by the general formula (1):
—[Si(R¹)_{2-b}(Y)_{b}O]ₘ—Si(R²)₃₋ₐ(Y)ₐ (1)
wherein each of R¹ and R² represents an alkyl group containing 1 to 20 carbon atoms, an aryl group containing 6 to 20 carbon atoms, an aralkyl group containing 7 to 20 carbon atoms, or a triorganosiloxy group represented by (R′)₃SiO—, wherein R′ represents a monovalent hydrocarbon group containing 1 to 20 carbon atoms, and three R′s may be identical to or different from one another, and when two or more R¹s or R²s exist, these may be identical to or different from one another; Y represents a hydroxyl group or a hydrolyzable group, and when two or more Ys exist, these may be identical to or different from one another; and a represents 0, 1, 2, or 3, b represents 0, 1, or 2, and m represents an integer between 0 and 19, which satisfies a+mb≧1.
